(19) United States
(12) Patent Application Publication
(10) Pub. No.: US 2011/0175920 A1
(43) Pub. Date: Jul. 21, 2011

(54) METHOD FOR HANDLING AND TRANSFERRING DATA IN AN INTERACTIVE INPUT SYSTEM, AND INTERACTIVE INPUT SYSTEM EXECUTING THE METHOD

(75) Inventor: Taco van Ieperen, Calgary (CA)

(73) Assignee: SMART Technologies ULC, Calgary (CA)

(21) Appl. No.: 12/967,475

(22) Filed: Dec. 14, 2010

Related U.S. Application Data
(60) Provisional application No. 61/294,829, filed on Jan. 13, 2010.

(51) Int. Cl. G06T 13/00; G06F 15/173; H04Q 5/22; G06F 3/041

(52) U.S. Cl. 345/473; 709/238; 340/10.1; 345/173

(57) ABSTRACT

A method in a computing device of transferring data to another computing device includes establishing wireless communication with the other computing device, designating data for transfer to the other computing device; and in the event that the computing device assumes a predetermined orientation, automatically initiating wireless transfer of the data to the other computing device. A system implementing the method is provided. A method of handling a graphic object in an interactive input system having a first display device includes defining a graphic object placement region for the first display device that comprises at least a visible display region of the first display device and an invisible auxiliary region between the visible display region and an outside edge of the first display device; and in the event that the graphic object enters the invisible auxiliary region, automatically moving the graphic object through the invisible auxiliary region until at least a portion of the graphic object enters a visible display region of a second display device of a second interactive input system. A system implementing the method, and other related systems and methods, are provided.

### FIELD OF THE INVENTION

The present invention relates generally to interactive input systems and in particular to methods for handling and transferring data in an interactive input system and other computing devices, and systems executing the methods.

### BACKGROUND OF THE INVENTION

Interactive input systems that allow users to inject input (i.e. digital ink, mouse events etc.) into an application program using an active pointer (eg. a pointer that emits light, sound or other signal), a passive pointer (eg. a finger, cylinder or other suitable object) or other suitable input device such as for example, a mouse or trackball, are known. These interactive input systems include but are not limited to: touch systems comprising touch panels employing analog resistive or machine vision technology to register pointer input such as those disclosed in U.S. Pat. Nos. 5,448,263; 6,141,000; 6,337,681; 6,747,636; 6,803,906; 7,232,986; 7,236,162; and 7,274,356 assigned to SMART Technologies ULC of Calgary, Alberta, Canada, assignee of the subject application, the contents of which are incorporated by reference; touch systems comprising touch panels employing electromagnetic, capacitive, acoustic or other technologies to register pointer input; tablet personal computers (PCs); laptop PCs; personal digital assistants (PDAs); and other similar devices.

Multi-touch interactive input systems that receive and process input from multiple pointers using machine vision are, also known. One such type of multi-touch interactive input system exploits the well-known optical phenomenon of frustrated total internal reflection (FTIR). According to the general principles of FTIR, the total internal reflection (TIR) of light traveling through an optical waveguide is frustrated when an object such as a pointer touches the waveguide surface, due to a change in the index of refraction of the waveguide, causing some light to escape from the touch point (“contact point”). In a multi-touch interactive input system, the machine vision system captures images including the point(s) of escaped light, and processes the images to identify the position of the pointers on the waveguide surface based on the point(s) of escaped light for use as input to application programs. One example of an FTIR multi-touch interactive input system is disclosed in United States Patent Application Publication No. 2008/0029691 to Han.

Multi-touch interactive input systems are well-suited to educational and collaborative environments, due particularly to their ability to receive and react to input from multiple users. In such environments, it can also be useful to cause two or more interactive input systems to be positioned alongside each other, and to systematically cooperate with each other, so as to enable data visually represented as one or more graphic objects being manipulated using a first interactive input system to, under certain conditions, become visible and manipulable at the second interactive input system, and vice versa.

Furthermore, it would be useful to enable other computing devices such as laptop computers, smartphones, tablet devices and the like to cooperate with such interactive input systems, and in doing so provide the appearance that the respective displays and, if applicable, touch surfaces of such computing devices are portions of one larger display.

Display systems involving multiple display devices positioned adjacent to each other and capable of representing one larger image are known. However, typically such display systems are not interactive input systems, and typically are controlled by a unitary processing structure that itself allocates portions of the large image to respective display devices.

U.S. Pat. No. 6,545,669 to Kinawi et al. discloses an apparatus and process that are provided for dragging or manipulating an object across a non-touch sensitive discontinuity between touch-sensitive screens of a computer. The object is selected and its parameters are stored in a buffer. The user activates means to trigger manipulation of the object from the source screen to the target screen. In one embodiment, a pointer is manipulated continuously on the source screen to effect the transfer. The object can be latched in a buffer for release on when the pointer contacts the target screen, preferably before a timer expires. Alternatively, the object is dragged in a gesture or to impinge a hot switch which directs the computer to release the object on the target screen. In a hardware embodiment, buttons on a wireless pointer can be invoked to specify cut, copy or menu options and hold the object in the buffer despite a pointer lift. In another software/hardware embodiment, the steps of source screen and object selection can be aided with eye-tracking and voice recognition hardware and software.

U.S. Pat. No. 6,573,913 to Butler et al, assigned to Microsoft Corporation, discloses systems and methods for repositioning and displaying objects in multiple monitor environments. When two or more of the monitors have different color characteristics, images moved between monitors are processed to take advantage of the particular color characteristics of the monitors, while reducing the processing resources that might otherwise be needed to entirely render the image from scratch. For instance, an image positioned within a first monitor space can be repositioned such that a first portion is displayed in the first monitor space and a second portion in the second monitor space. The data representing the first portion of the image is moved from a first location to a second location in a frame buffer in a bit block transfer operation. If the first and second monitors have the same color characteristics, the data representing a second portion is also transferred using a bit block operation. However, if the color characteristics are different, the data representing the second portion of the image is passed through a display engine that adapts the data to the particular color characteristics of the second monitor.

While the above-described techniques provide enhancements, improvements are desirable.

### SUMMARY OF THE INVENTION

In accordance with an aspect, there is provided a method in a computing device of transferring data to another computing device comprising:

establishing wireless communication with the other computing device;

designating data for transfer to the other computing device; and

in the event that the computing device assumes a predetermined orientation, automatically initiating wireless transfer of the data to the other computing device.

In accordance with another aspect, there is provided a system in a computing device for transferring data to another computing device, comprising:

a wireless communications interface establishing wireless communication with the other computing device;

a user interface receiving user input for designating data for transfer to the other computing device;

a sensor for sensing orientation of the computing device; and

processing structure for, in the event that the sensor senses a predetermined orientation, automatically initiating wireless transfer of the data to the other computing device.

In accordance with another aspect, there is provided a computer readable medium embodying a computer program executable on a processing structure of a computing device for transferring data to another computing device, the computer program comprising:

computer program code for establishing a wireless communications with the other computing device;

computer program code for designating data for transfer to the other computing device; and

computer program code for automatically initiating wireless transfer of the data to the other computing device, in the event that the computing device assumes a predetermined orientation.

In accordance with another aspect, there is provided an interactive input system comprising:

a first display device; and

processing structure communicating with the first display device, the processing structure defining a graphic object placement region for the first display device that comprises at least a visible display region of the first display device and an invisible auxiliary region between the visible display region and an outside edge of the first display device, the processing structure, in the event that the graphic object enters the invisible auxiliary region, automatically moving the graphic object through the invisible auxiliary region until at least a portion of the graphic object enters a visible display region of a second display device of a second interactive input system.

In accordance with another aspect, there is provided a method of handling a graphic object in an interactive input system having a first display device, the method comprising:

defining a graphic object placement region for the first display device that comprises at least a visible display region of the first display device and an invisible auxiliary region between the visible display region and an outside edge of the first display device; and

in the event that the graphic object enters the invisible auxiliary region, automatically moving the graphic object through the invisible auxiliary region until at least a portion of the graphic object enters a visible display region of a second display device of a second interactive input system.

In accordance with another aspect, there is provided a computer readable medium embodying a computer program for handling a graphic object in an interactive input system having a first display device, the computer program comprising:

program code for defining a graphic object placement region for the first display device that comprises at least a visible display region of the first display device and an invisible auxiliary region between the visible display region and an outside edge of the first display device; and

program code for, in the event that the graphic object enters the invisible auxiliary region, automatically moving the graphic object through the invisible auxiliary region until at least a portion of the graphic object enters a visible display region of a second display device of a second interactive input system.

In accordance with another aspect, there is provided an interactive input system comprising:

a first display device positioned near to a second display device of another interactive input system; and

processing structure communicating with the first display device, the processing structure defining a transition region comprising a portion of a visible display region of the first display device and portion of a visible display region of the second display device, the first visible display region having a different orientation than the second visible display region, the processing structure, in the event that the graphic object enters the transition region, automatically reorienting the graphic object by rotating the graphic object, wherein the angle of rotation is based on the distance the graphic object has traveled through the transition region.

In accordance with another aspect, there is provided a method of handling a graphic object in an interactive input system having a first display device positioned near to a second display device of a second interactive input system, the method comprising:

defining a transition region comprising a portion of a visible display region of the first display device and portion of a visible display region of the second display device, the first visible display region having a different orientation than the second visible display region; and

in the event that the graphic object enters the transition region, automatically reorienting the graphic object by rotating the graphic object, wherein the angle of rotation is based on the distance the graphic object has traveled through the transition region.

In accordance with another aspect, there is provided a computer readable medium embodying a computer program for handling a graphic object in an interactive input system having a first display device positioned near to a second display device of a second interactive input system, the computer program comprising:

program code for defining a transition region comprising a portion of a visible display region of the first display device and portion of a visible display region of the second display device, the first visible display region having a different orientation than the second visible display region; and

program code for, in the event that the graphic object enters the transition region, automatically reorienting the graphic object by rotating the graphic object, wherein the angle of rotation is based on the distance the graphic object has traveled through the transition region.

In accordance with another aspect, there is provided an interactive input system comprising:

a first display device; processing structure receiving data for contact points on a graphic object from both the interactive input system and another interactive input system, the processing structure aggregating the contact points and, based on the aggregated contact points, manipulating the graphic object, the processing structure updating the first and second interactive input systems based on the manipulating.

In accordance with another aspect, there is provided a method of manipulating a graphic object presented on both a first interactive input system and a second interactive input system, the method comprising:

receiving data for contact points on the graphic object made via both the first interactive input system and the second interactive input system;

aggregating the contact points;

based on the aggregated contact points, manipulating the graphic object; and

updating the first and second interactive input systems based on the manipulating.

In accordance with another aspect, there is provided a computer readable medium embodying a computer program for manipulating a graphic object presented on both a first interactive input system and a second interactive input system, the computer program comprising:

program code for receiving data for contact points on the graphic object made via both the first interactive input system and the second interactive input system;

program code for aggregating the contact points;

program code for, based on the aggregated contact points, manipulating the graphic object; and

program code for updating the first and second interactive input systems based on the manipulating.

Embodiments described herein provide enhancements to the collaborative value of interactive input systems by enabling multiple interactive input systems to work seamlessly together, or by enabling other devices such as laptop computers to transfer data to and from interactive input systems or other computing devices. Certain embodiments provided herein are advantageous at least for enabling a user to transfer data from an originating computing device, which is preferably portable, to a receiving other computing device that is nearby simply by orienting the originating computing device in a predetermined manner. The predetermined manner may be tilting the originating computing device from a horizontal position as though the data were being dropped onto the other computing device, rather than requiring the user of the computing device to execute a number of complex keystrokes or touch gestures. Such would be useful for a teacher in a classroom carrying a portable computing device and “dropping” data such as objects, drawing files, question objects, word processing files and the like onto an interactive input system, where the “dropped” data would actually be a copy of the data on the portable computing device and would become usable by the students in application programs running on the touch table.

### BRIEF DESCRIPTION OF THE DRAWINGS

Embodiments will now be described more fully with reference to the accompanying drawings in which:

FIG. 1 is a perspective view of an interactive input system in the form of a touch table;

FIG. 2 is a side sectional view of the touch table of FIG. 1;

FIG. 3 is a sectional view of a table top and touch panel forming part of the touch table of FIG. 1;

FIG. 4 is a block diagram illustrating the software structure of the touch table;

FIGS. 5A-5D illustrate an object being moved from the display screen of one touch table to the display screen of another touch table;

FIG. 6A is a flowchart showing steps in a main application loop executed on the touch table;

FIG. 6B is the flowchart showing steps in a “Send Updated Positions for Locally Owned Items” process of the main application loop;

FIG. 6C is a flowchart showing steps in a “Get Network Updates” process of the main application loop;

FIGS. 7A-7C an object being moved from one touch table to another touch table in another embodiment;

FIGS. 8A-8B and 9A-B show manipulation of objects that are large enough to partly span two touch tables using touches on each of the two touch tables;

FIG. 10 is a flowchart showing steps in a main application loop for simultaneous manipulation across two multi-touch tables;

FIG. 11 is a flowchart showing steps in a “Handle Local Hardware Contacts” process of the main application loop for simultaneous manipulation across two multi-touch tables;

FIG. 12 is a flowchart showing steps in an “Update Position of Object” process of the main application loop for simultaneous across two multi-touch tables;

FIG. 13 is a flowchart showing steps in a “Send Updated Positions for Locally Owned Items” process of the main application loop for simultaneous manipulation across two multi-touch tables;

FIG. 14 is a flowchart showing steps in a “Get Network Updates” process of the main application loop for simultaneous manipulation across two multi-touch tables;

FIG. 15 is a side sectional view of an alternative touch table interactive input system;

FIG. 16 is a block diagram illustrating components in a laptop computer of a system for transferring data to another computing device;

FIGS. 17A-17C show an object being “dropped” from a laptop computer to the touch table;

FIG. 18 is a flowchart showing steps in a method executed in an object Sender Service running on the laptop computer;

FIG. 19 is a flowchart showing steps in a method executed in an object Receiver Service running on the alternative touch table;

FIGS. 20A and 20B show an originating laptop computer being tilted towards a destination laptop computer to trigger “dropping” of an object onto the destination laptop computer;

FIGS. 21A-21D shows the display screen of the originating laptop computer as it is being tilted towards the destination laptop computer on which the object is being dropped;

FIGS. 22A-22C show the display screen of the destination laptop computer as the dropped object is being received from the originating laptop computer; and

FIG. 23 is a flowchart showings steps during a tilt motion of the originating laptop computer.

### DETAILED DESCRIPTION OF THE EMBODIMENTS

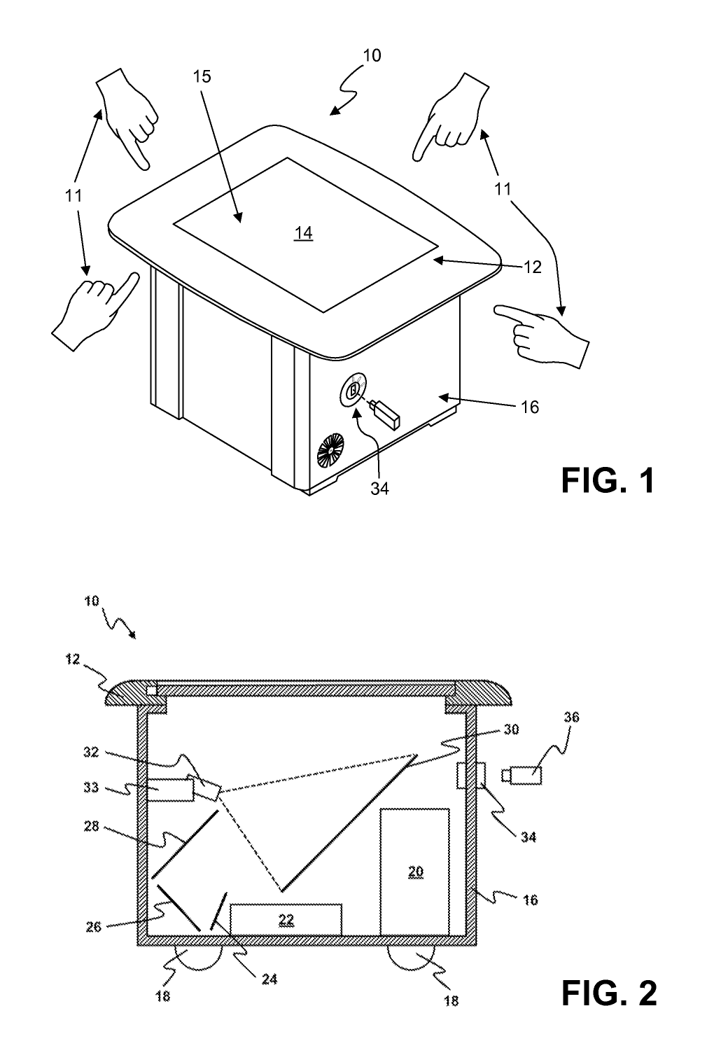

Turning now to FIGS. 1 and 2, there are shown a perspective diagram and a sectional side view of an interactive input system in the form of a touch table generally identified by reference numeral 10. Touch table 10 comprises a table top 12 mounted atop a cabinet 16. In this embodiment, cabinet 16 sits atop wheels, castors or the like 18 that enable the touch table 10 to be easily moved from place to place as requested. Integrated into table top 12 is a coordinate input device in the form of a frustrated total internal reflection (FTIR) based touch panel 14 that enables detection and tracking of one or more pointers 11, such as fingers, pens, hands, cylinders, or other objects, applied thereto.

Cabinet 16 supports the table top 12 and touch panel 14, and houses a processing structure 20 executing a host application and one or more application programs. Image data generated by the processing structure 20 is displayed on the touch panel 14 allowing a user to interact with the displayed image via pointer contacts on the display surface 15 of the touch panel 14. The processing structure 20 interprets pointer contacts as input to the running application program and updates the image data accordingly so that the image displayed on the display surface 15 reflects the pointer activity. In this manner, the touch panel 14 and processing structure 20 form a closed loop allowing pointer interactions with the touch panel 14 to be recorded as handwriting or drawing or used to control execution of the application program.

Processing structure 20 in this embodiment is a general purpose computing device in the form of a computer. The computer comprises for example, a processing unit, system memory (volatile and/or non-volatile memory), other non-removable or removable memory (a hard disk drive, RAM, ROM, EEPROM, CD-ROM, DVD, flash memory etc.) and a system bus coupling the various computer components to the processing unit.

During execution of the host software application/operating system run by the processing structure 20, a graphical user interface comprising a canvas page or palette (i.e. background), upon which visual representations of data in the form of graphic widgets or objects are displayed, is displayed on the display surface of the touch panel 14. In this embodiment, the graphical user interface enables freeform or handwritten ink objects and other objects to be input and manipulated via pointer interaction with the display surface 15 of the touch panel 14.

The cabinet 16 also houses a horizontally-oriented projector 22, an infrared (IR) filter 24, and mirrors 26, 28 and 30. An imaging device 32 in the form of an infrared-detecting camera is mounted on a bracket 33 adjacent mirror 28. The system of mirrors 26, 28 and 30 functions to “fold” the images projected by projector 22 within cabinet 16 along the light path without unduly sacrificing image size. The overall touch table 10 dimensions can thereby be made compact.

The imaging device 32 is aimed at mirror 30 and thus sees a reflection of the display surface 15 in order to mitigate the appearance of hotspot noise in captured images that typically must be dealt with in systems having imaging devices that are aimed directly at the display surface itself. Imaging device 32 is positioned within the cabinet 16 by the bracket 33 so that it does not interfere with the light path of the projected image.

During operation of the touch table 10, processing structure 20 outputs video data to projector 22 which, in turn, projects images through the IR filter 24 onto the first mirror 26. The projected images, now with IR light having been substantially filtered out, are reflected by the first mirror 26 onto the second mirror 28. Second mirror 28 in turn reflects the images to the third mirror 30. The third mirror 30 reflects the projected video images onto the display (bottom) surface of the touch panel 14. The video images projected on the bottom surface of the touch panel 14 are viewable through the touch panel 14 from above. The system of three mirrors 26, 28, 30 configured as shown provides a compact path along which the projected image can be channelled to the display surface. Projector 22 is oriented horizontally in order to preserve projector bulb life, as commonly-available projectors are typically designed for horizontal placement.

An external data port/switch 34, in this embodiment a Universal Serial Bus (USB) port/switch, extends from the interior of the cabinet 16 through the cabinet wall to the exterior of the touch table 10 providing access for insertion and removal of a USB key 36, as well as switching of functions.

The USB port/switch 34, projector 22, and IR-detecting camera 32 are each connected to and managed by the processing structure 20. A power supply (not shown) supplies electrical power to the electrical components of the touch table 10. The power supply may be an external unit or, for example, a universal power supply within the cabinet 16 for improving portability of the touch table 10. The cabinet 16 fully encloses its contents in order to restrict the levels of ambient visible and infrared light entering the cabinet 16 thereby to facilitate satisfactory signal to noise performance. Doing this can compete with various techniques for managing heat within the cabinet 16. The touch panel 14, the projector 22, and the processing structure are all sources of heat, and such heat if contained within the cabinet 16 for extended periods of time can reduce the life of components, affect performance of components, and create heat waves that can distort the optical components of the touch table 10. As such, the cabinet 16 houses heat managing provisions (not shown) to introduce cooler ambient air into the cabinet while exhausting hot air from the cabinet. For example, the heat management provisions may be of the type disclosed in U.S. patent application Ser. No. 12/240,953 to Sirotich et al., filed on Sep. 29, 2008 entitled “TOUCH PANEL FOR INTERACTIVE INPUT SYSTEM AND INTERACTIVE INPUT SYSTEM EMPLOYING THE TOUCH PANEL” and assigned to SMART Technologies ULC of Calgary, Alberta, the assignee of the subject application, the content of which is incorporated herein by reference.

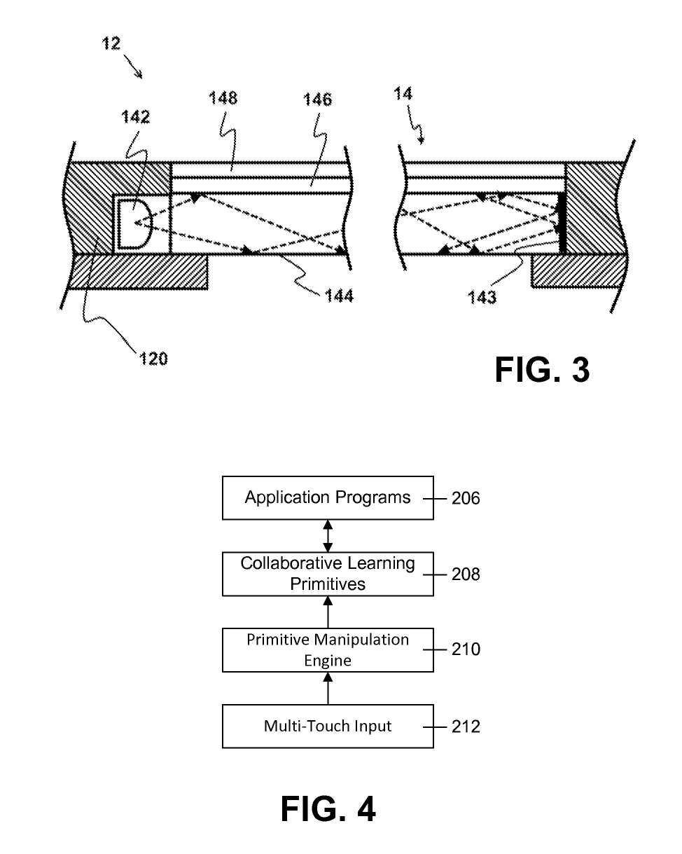

As set out above, the touch panel 14 of touch table 10 operates based on the principles of frustrated total internal reflection (FTIR), as described in further detail in the above-mentioned U.S. patent application Ser. No. 12/240,953 to Sirotich et al., referred to above. FIG. 3 is a sectional view of the table top 12 and touch panel 14. Table top 12 comprises a frame 120 formed of plastic supporting the touch panel 14.

Touch panel 14 comprises an optical waveguide 144 that, according to this embodiment, is a sheet of acrylic. A resilient diffusion layer 146, in this embodiment a layer of V-CARE® V-LITE® barrier fabric manufactured by Vintex Inc. of Mount Forest, Ontario, Canada, or other suitable material lies against the optical waveguide 144.

The diffusion layer 146, when pressed into contact with the optical waveguide 144, substantially reflects the IR light escaping the optical waveguide 144 so that the escaping IR light travels down into the cabinet 16. The diffusion layer 146 also diffuses visible light being projected onto it in order to display the projected image.

Overlying the resilient diffusion layer 146 on the opposite side of the optical waveguide 144 is a clear, protective layer 148 having a smooth touch surface. In this embodiment, the protective layer 148 is a thin sheet of polycarbonate material over which is applied a hardcoat of Marnot® material, manufactured by Tekra Corporation of New Berlin, Wis., U.S.A. While the touch panel 14 may function without the protective layer 148, the protective layer 148 permits use of the touch panel 14 without undue discoloration, snagging or creasing of the underlying diffusion layer 146, and without undue wear on users' fingers. Furthermore, the protective layer 148 provides abrasion, scratch and chemical resistance to the overall touch panel 14, as is useful for panel longevity.

The protective layer 148, diffusion layer 146, and optical waveguide 144 are clamped together at their edges as a unit and mounted within the table top 12. Over time, prolonged use may wear one or more of the layers. As desired, the edges of the layers may be unclamped in order to inexpensively provide replacements for the worn layers. It will be understood that the layers may be kept together in other ways, such as by use of one or more of adhesives, friction fit, screws, nails, or other fastening methods.

An IR light source comprising a bank of infrared light emitting diodes (LEDs) 142 is positioned along at least one side surface of the optical waveguide 144. Each LED 142 emits infrared light into the optical waveguide 144. In this embodiment, the side surface along which the IR LEDs 142 are positioned is flame-polished to facilitate reception of light from the IR LEDs 142. An air gap of 1-2 millimetres (mm) is maintained between the IR LEDs 142 and the side surface of the optical waveguide 144 in order to reduce heat transmittance from the IR LEDs 142 to the optical waveguide 144, and thereby mitigate heat distortions in the acrylic optical waveguide 144. Bonded to the other side surfaces of the optical waveguide 144 is reflective tape 143 to reflect light back into the optical waveguide 144 thereby saturating the optical waveguide 144 with infrared illumination.

In operation, IR light is introduced via the flame-polished side surface of the optical waveguide 144 in a direction generally parallel to its large upper and lower surfaces. The IR light does not escape through the upper or lower surfaces of the optical waveguide 144 due to total internal reflection (TIR) because its angle of incidence at the upper and lower surfaces is not sufficient to allow for its escape. The IR light reaching other side surfaces is generally reflected entirely back into the optical waveguide 144 by the reflective tape 143 at the other side surfaces.

When a user contacts the display surface of the touch panel 14 with a pointer 11, the pressure of the pointer 11 against the protective layer 148 compresses the resilient diffusion layer 146 against the optical waveguide 144, causing the index of refraction on the optical waveguide 144 at the contact point of the pointer 11, or “touch point,” to change. This change “frustrates” the TIR at the touch point causing IR light to reflect at an angle that allows it to escape from the optical waveguide 144 in a direction generally perpendicular to the plane of the optical waveguide 144 at the touch point. The escaping IR light reflects off of the point 11 and scatters locally downward through the optical waveguide 144 and exits the optical waveguide 144 through its bottom surface. This occurs for each pointer 11 as it contacts the display surface of the touch panel 114 at a respective touch point.

As each touch point is moved along the display surface 15 of the touch panel 14, the compression of the resilient diffusion layer 146 against the optical waveguide 144 occurs and thus escaping of IR light tracks the touch point movement. During touch point movement or upon removal of the touch point, decompression of the diffusion layer 146 where the touch point had previously been due to the resilience of the diffusion layer 146, causes escape of IR light from optical waveguide 144 to once again cease. As such, IR light escapes from the optical waveguide 144 only at touch point location(s) allowing the IR light to be captured in image frames acquired by the imaging device.

The imaging device 32 captures two-dimensional, IR video images of the third mirror 30. IR light having been filtered from the images projected by projector 22, in combination with the cabinet 16 substantially keeping out ambient light, ensures that the background of the images captured by imaging device 32 is substantially black. When the display surface 15 of the touch panel 14 is contacted by one or more pointers as described above, the images captured by IR camera 32 comprise one or more bright points corresponding to respective touch points. The processing structure 20 receives the captured images and performs image processing to detect the coordinates and characteristics of the one or more touch points based on the one or more bright points in the captured images. The detected coordinates are then mapped to display coordinates and interpreted as ink or mouse events by the processing structure 20 for manipulating the displayed image.

In embodiments, the size of each touch point is also detected, and is compared with the previously detected size of the same touch point for establishing a level of pressure of the touch point. For example, if the size of the touch point increases, the pressure is considered to increase. Alternatively, if the size of the touch point decreases, the pressure is considered to decrease.

FIG. 4 is a block diagram illustrating the software structure of the touch table interactive input system 10. A primitive manipulation engine 210, part of the host application, monitors the touch panel 14 to capture touch point data 212 and generate contact events. The primitive manipulation engine 210 also analyzes touch point data 212 and recognizes known gestures made by touch points. The generated contact events and recognized gestures are then provided by the host application to the collaborative learning primitives 208 which include graphic objects 106 such as for example the canvas, buttons, images, shapes, video clips, freeform and ink objects. The application programs 206 organize and manipulate the collaborative learning primitives 208 to respond to one or more users' input. At the instruction of the application programs 206, the collaborative learning primitives 208 modify the image displayed on the display surface 15 to respond to users' interaction.

The primitive manipulation engine 210 tracks each touch point based on the touch point data 212, and handles continuity processing between image frames. More particularly, the primitive manipulation engine 210 receives touch point data 212 from frames and based on the touch point data 212 determines whether to register a new touch point, modify an existing touch point, or cancel/delete an existing touch point. Thus, the primitive manipulation engine 210 registers a contact down event representing a new touch point when it receives touch point data 212 that is not related to an existing touch point, and accords the new touch point a unique identifier. Touch point data 212 may be considered unrelated to an existing touch point if it characterizes a touch point that is a threshold distance away from an existing touch point, for example. The primitive manipulation engine 210 registers a contact move event representing movement of the touch point when it receives touch point data 212 that is related to an existing pointer, for example by being within a threshold distance of, or overlapping an existing touch point, but having a different focal point. The primitive manipulation engine 210 registers a contact up event representing removal of the touch point from the surface of the touch panel 104 when reception of touch point data 212 that can be associated with an existing touch point ceases to be received from subsequent images. The contact down, move and up events are passed to respective collaborative learning primitives 208 of the user interface such as graphic objects 106, widgets, or the background or canvas 108, based on which of these the touch point is currently associated with, and/or the touch point's current position.

The users of the touch table 10 may comprise content developers, such as teachers, and learners. Content developers communicate with application programs running on touch table 10 to set up rules and scenarios. A USB key 36 (see FIG. 1B) may be used by content developers to store and upload to touch table 10 updates to the application programs with developed content. The USB key 36 may also be used to identify the content developer. Learners communicate with application programs by touching the display surface 15 as described above. The application programs respond to the learners in accordance with the touch input received and the rules set by the content developer.

Application programs 206 organize and manipulate collaborative learning primitives 208 in accordance with user input to achieve different behaviours, such as scaling, rotating, and moving. The application programs 206 may detect the release of a first graphic object over a second graphic object, and invoke functions that exploit relative position information of the objects. Such functions may include those functions handling object matching, mapping, and/or sorting. Content developers may employ such basic functions to develop and implement collaboration scenarios and rules. Moreover, these application programs 206 may be provided by the provider of the touch table 10 or by third party programmers developing applications based on a software development kit (SDK) for the touch table 10.

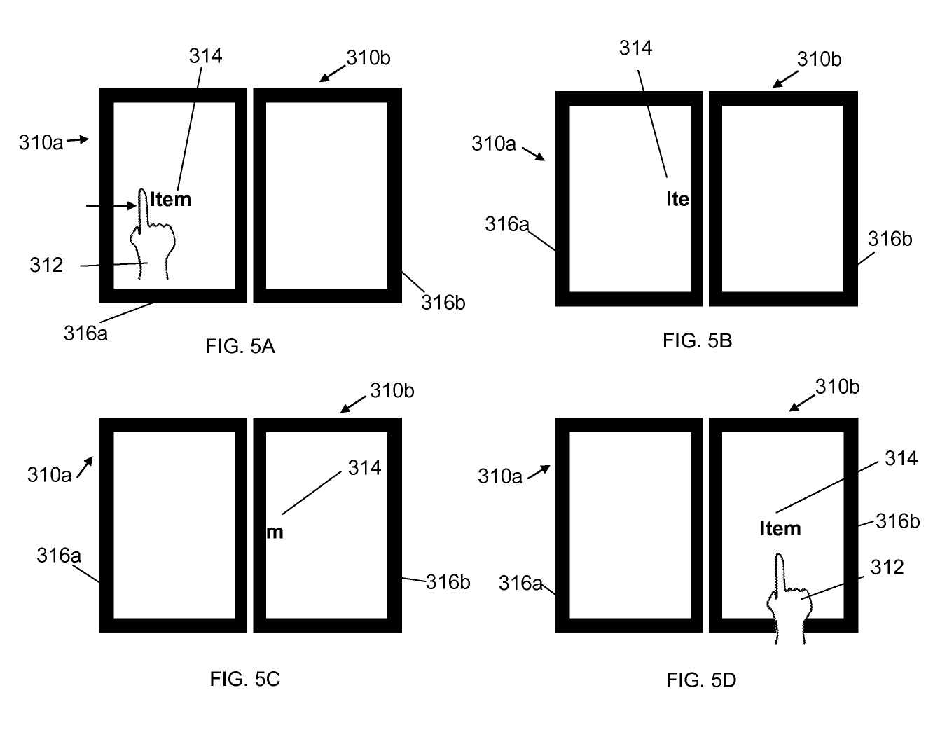

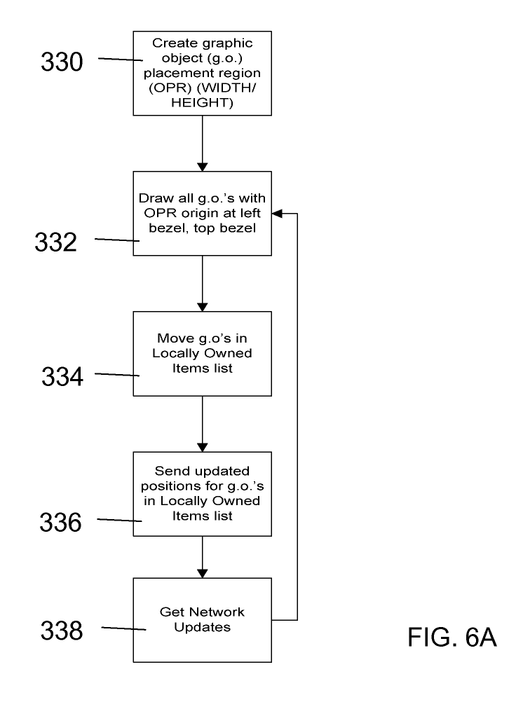

As described above, advantages can accrue from enabling two or more interactive input systems such as that described above to cooperate, and in doing so provide the appearance that the touch surfaces of the respective interactive input systems are portions of one larger touch surface. FIGS. 5A to 5D illustrate schematically a first display device corresponding to a first touch surface 310a of a first interactive input system positioned adjacent a second display device corresponding to a second touch surface 310b of a second interactive input system.

In this example, a graphic object 314 labeled “Item” is first displayed in the visible region of the first touch surface 310a, and has been selected by contacting the first touch surface 310a at a position corresponding to the graphic object 314 with a pointer 312, in this case the user's finger. Progressively through FIGS. 5A to 5D, the graphic object 314 is moved across the first touch surface 310a, under the bezel 316a that surrounds the first touch surface 310a, under the bezel 316b that surrounds the second touch surface 310b, and into the visible display region of the second touch surface 310b, where graphic object 314 can be manipulated via the second touch surface 310b.

It will be observed that, in FIGS. 5A to 5D, the portion of the graphic object 314 that has left the visible region of the first touch surface 310a is not immediately made visible in the visible display region of the second touch surface 310b as the graphic object 314 is moved. That is, the bezels 316a and 316b between the visible display regions of the first and second touch surfaces 310a and 310b appear to occlude a portion of the coincident graphic object 314, as though the graphic object 314 were in fact underneath the bezels 316a, 316b. It is typically the case that an interactive input system such as is described herein has a frame such as bezels 316a, 316b surrounding the visible display regions of the interactive input systems. Thus, rather than cause visual discontinuity by treating the bezels 316a and 316b as though they were not in fact present between the visible display regions, a much stronger metaphor is provided by accounting for the presence of the bezels 316a and 316b and treating the bezel area or a portion thereof as part of the object placement region. In this embodiment therefore, the object placement region for the first interactive input system includes its visible display region in combination with an invisible auxiliary region between the visible display region and an outside edge of the first display device.

It will be understood that the object placement region for the first interactive input system includes the visible display area and the entire bezel 316a surrounding the visible display area. The graphic object 314 is therefore permitted to be moved into an area that causes the graphic object 314 to be at least partly invisible such that it appears to be occluded by the bezel 316a. In an alternative embodiment, however, the object placement region includes the visible display area and the invisible auxiliary region that is only the portion of the bezel 316a falling between the visible display area and the outside edge of the first display device.

In a similar manner an object placement region for the second interactive input system in this embodiment includes its visible display region in combination with an invisible auxiliary region between the visible display region and an outside edge of the second display device. In this case, the outside edge of the second display device is adjacent to the first display device.

It will be understood that the size and nature of the invisible auxiliary region for the first and second interactive input systems are preferably configurable. For example, it may not be physically possible due to room constraints or the like to place the display devices of the first and second interactive input systems immediately adjacent to each other such that a small space is left between the display devices. In this event, one or both of the interactive input systems may be configured to have an object placement region that includes all or a portion of the small space in addition to the region corresponding to its bezel. In some embodiments, the one or more interactive input systems comprise a distance measuring means, for example a laser or ultrasonic distance-measuring system that automatically determines the distance from one interactive input system to another. Such distance may also be manually configurable by an administrator, for example.

Because, according to the above, a graphic object 314 becomes at least partly invisible if coincident with one or both of the auxiliary regions as described above, a graphic object 314 could be positioned substantially entirely within the auxiliary regions and therefore be substantially completely invisible. In such a situation, manipulating the graphic object 314 could be very challenging, if not impossible, for a user using the means of selecting with a pointer. Furthermore, should the graphic object be smaller in dimension than the width of the combined auxiliary regions, moving the graphic object from one touch surface 310a to the other touch surface 310b using an ordinary translation gesture such as for example dragging the graphic object, for manipulation via the other touch surface 310b would not be possible.

In order to address this, according to this embodiment, the interactive input system supports a “throwing” gesture whereby the graphic object being moved in a particular direction continues to be moved in that direction, and at the same speed, even after the pointer is lifted from the touch surface. In the visible display region, the area across which the graphic object is moved is associated with a predefined friction factor, such that the graphic object being “thrown” at an initial speed is eventually slowed to a stop at a point that depends upon the initial speed, the friction factor and the trajectory of the throw. Preferably, the friction factor is constant throughout the visible display region, though alternatives are possible.

On the other hand, the auxiliary region of each interactive input system is treated as frictionless. More particularly, in the event that a thrown graphic object enters the invisible auxiliary region, the graphic object is automatically moved through the invisible auxiliary region at least until a portion of the graphic object enters a visible display region of the second display device. In this embodiment, the graphic object is automatically moved at substantially the same speed and with substantially the same trajectory as it had when it entered the invisible auxiliary region. In this way, a graphic object will not remain invisible in the auxiliary region indefinitely. In the event that the trajectory has a Y (vertical) component, should the Y position of the graphic object being automatically moved reach the minimum or maximum Y value permitted by the object placement region of one or both interactive input systems, the Y value is maintained at that value and the X value continued to increase until the graphic object becomes visible and selectable again.

Alternatively, the object could be made to bounce off of the upper or lower boundaries by reversing the Y value automatically at a rate that accords with the friction factor.

In order to further enhance usability, velocity-based conditions are incorporated. For example, a graphic object that is moving very slowly into an invisible auxiliary region could take a long time to become available again in another visible display region. If a graphic object spends too much time getting across the invisible auxiliary region, users may become frustrated. In one embodiment therefore, a graphic object having a velocity that is below a threshold amount when entering an auxiliary region is automatically configured to somewhat increase its velocity as it moves through the auxiliary region. While this provision is useful, should the velocity be increased too much, the strong visual metaphor would be lost, since the space between display regions would appear either not to exist or to be smaller than would be expected. Therefore, preferably a graphic object having a velocity that is below a threshold amount is prevented from moving into the auxiliary region. Thus, the appearance is given of an area of increased friction near the inner edge of the bezel (eg. at the interface between the visible display region and the invisible auxiliary region). As a result, a user learns to throw a graphic object sufficiently “hard” at the auxiliary region when it is desired to have the graphic object continue sufficiently quickly through the invisible auxiliary region.

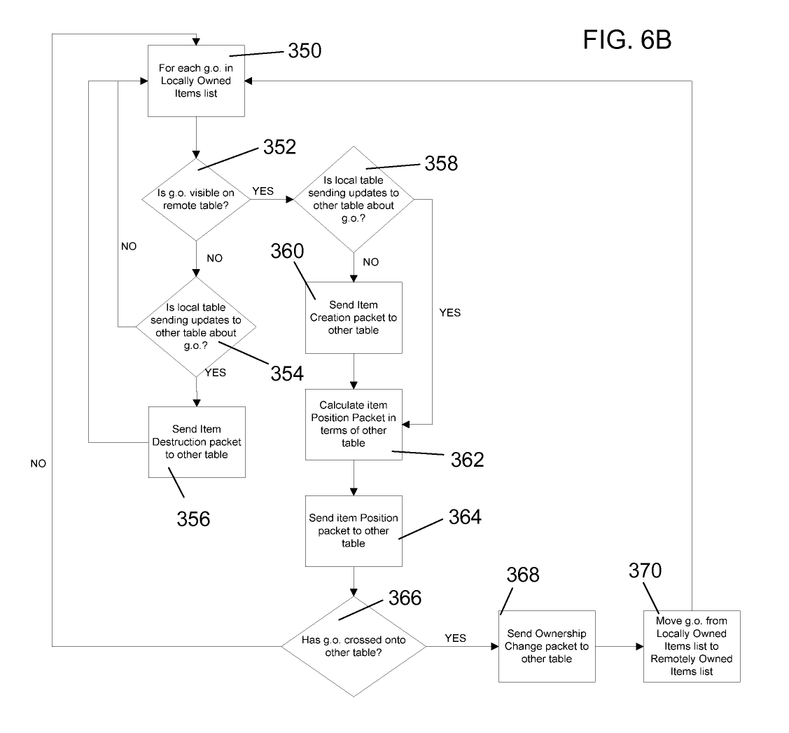

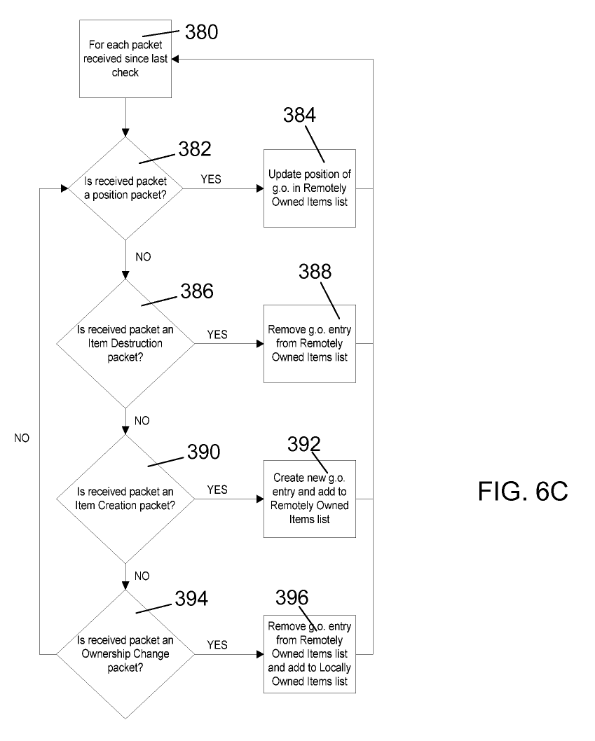

FIG. 6A is the flowchart for the main application loop for this embodiment that runs on each interactive input system. First, the object placement region (OPR) is defined to have a size corresponding to the visible display region in combination with the size of the bezels, and is positioned with its origin at the top left corner of the display device (eg. where the top bezel and the left bezel meet) (step 330). In this embodiment, the object placement region is configured to correspond to the physical width and height of the display device itself.

The host application of each interactive input system maintains a list of Locally Owned Items, in order to keep track of graphic objects that are positioned within its local object placement region. More particularly, a graphic object is in the Locally Owned Items list if its center point is within its local object placement region. The host application also maintains a list of Remotely Owned Items, in order to keep track of graphic objects that are positioned within a remote object placement region (eg. an object placement region of another interactive input system).

With the object placement region having been defined, graphic objects in the Locally Owned Items list are then drawn within the object placement region (step 332).

Graphic objects in the object placement region may be manipulated as required (step 334) using gesture input via a pointer such as a finger. Periodically, the current properties of graphic objects, such as for example their positions, sizes, scale and angle of rotation are provided as update packets to the other interactive input system if the given graphic object is listed in the Remotely Owned Items list of the other interactive input system (step 336). A given graphic object would be listed in the Remotely Owned Items list of the other interactive input system if the graphic object is positioned such that a portion of the graphic object is within the visible display region of the other interactive input system. As will be described further below, the given graphic object would otherwise be listed in the Remotely Owned Items list of the other interactive input system if the graphic object had been positioned such that a portion of the graphic object was (perhaps recently) within the visible display region of the other interactive input system though currently only within only the invisible auxiliary region of the other interactive input system.

With the updated properties having been provided to the other interactive input system the host application analyzes any update packets (or other types of packets as will be described) that the host application has received from the other interactive input system (step 338).

FIG. 6B is a flowchart showing in further detail the steps of the “Sending Updated Positions for Certain Locally Owned Items” step of the main application loop (FIG. 4A). This step is performed for each graphic object that is listed in the Locally Owned Items list (step 350). First, it is determined whether any portion of the graphic object is currently within the visible display region of the other interactive input system (step 352). If not, the process continues to step 354 where it is determined whether property update packets are currently being sent to the other interactive input system. If not, the process then reverts back to step 350 to select another graphic object in the Locally Owned Items list.

If it is determined at step 354 that property update packets for the graphic object are currently being provided to the other interactive input system, then because no further update packets are required the other interactive input system is provided with an Item Destruction Packet in respect of the graphic object in order to remove the graphic object from its Remotely Owned Items list (step 356). The process then reverts back to step 350 to select another graphic object in the Locally Owned Items list.

If, at step 352, a graphic object is at least partly visible on the display device of the other interactive input system, property update packets are required to be sent to the other interactive input system. In the event that, at step 358, it is determined that such property update packets are indeed being sent, the properties of the graphic object including its position are provided to the other interactive input system by way of a property update packet. However, if at step 358 it is determined that property update packets are not being sent, as would be the case if the graphic object had not previously been positioned such that a portion of the graphic object coincided with the visible display region of the other interactive input system, than an Item Creation packet is provided to the other interactive input system (step 360). The provision of the Item Creation packet to the other interactive input system causes the other interactive input system to enter the graphic object into its Remotely Owned Items list, to display the graphic object in the visible display region of the other interactive input system in accordance with its properties, to become prepared to periodically receive property update packets in respect of that graphic object, and to update the properties of the graphic object being displayed by the other interactive input system in accordance with updates received. With the Item Creation packet having been provided to the other interactive input system, the process continues to step 362, where the interactive input system calculates the properties of the graphic object for providing a property update packet to the other interactive input system, as will be described.

If, at step 358, property update packets are already being provided between the interactive input systems, then no Item Creation packet is required.

During calculation of the properties of the graphic object for providing a property update packet, the interactive input system calculates properties in terms of the other interactive input system. For example, while the center position of the graphic object in the interactive input system will be at particular coordinates in respect of the interactive input system, provision of these coordinates unprocessed to the other interactive input system would cause the graphic object to be displayed just as it is displayed on the interactive input system.

In this embodiment, the calculation of object position by the table interactive input system in terms of a position on the other table interactive input system is done according to the software code listed in Code Listing A, below, or similar:

Code Listing A

// assumes width and height of the table displays are the same on all tables
// coordinate system is such that my table goes from
// 0,0 to width+leftbezel+rightbezel,height+topbezel+bottombezel.
void CalculateItemPositionOnRemoteTable( Position original)

{
if ( MyTable.Right connectsto RemoteTable.Left)

{
original.X.Subtract( width+rightbezel+leftbezel,0);
return original;
}

if ( MyTable.Left connectsto RemoteTable.Right)

{
original.X.Add( width+leftbezel+rightbezel,0);
return original;
}

if (MyTable.Right connectsto RemoteTable.Right)
//other table upside down relative to this table

{
original.X.original=(width+leftbezel+rightbezel)*2−original.X;
original.Y=(height+topbezel+bottombezel)−original.Y;
return original;
}

if (MyTable.Left connectsto RemoteTable.Left)
//other table upside down relative to this table

{
original.X=−original.X;
original.Y=(height+topbezel+bottombezel)−original.Y;
return original;
}

}

With the position of the graphic object in respect of the other interactive input system having been calculated, the position is provided in a property update packet to the other interactive input system (step 364) for updating the graphic object position in the other interactive input system. It will be understood that other properties of the graphic object, such as angle of rotation, may be provided by way of the same or a different property update packet in a similar manner. Certain property changes, such as color changes, would not generally require a conversion in terms of the other interactive input system as has been described above for position.

With the property update packet having been provided to the other interactive input system, it is then determined whether the center point of the graphic object is itself now outside of the object placement region (step 366). In the event that the center point of the graphic object is not outside of the object placement region, the process reverts to step 350 to deal with any other graphic objects in a similar manner as has been described above. Otherwise, if at step 366 the center point is outside of the object placement region, an Ownership Change packet is created and provided to the other interactive input system (step 368), and the entry for the graphic object is removed from the Locally Owned Items list and an entry for the graphic object is inserted into the Remotely Owned Items list (step 370). Provision of the Ownership change packet informs the other interactive input system that it now should be inserting an entry for the graphic object into its Locally Owned Items list and removing the entry for the graphic object from its Remotely Owned Items list.

FIG. 6C is a flowchart detailing the “Get Network Updates” process of the main application loop (FIG. 6A). During this process, the interactive input system reviews each packet (whether it is a property update packet, an ownership change packet, an item creation packet or an item destruction packet) received from the other interactive input system since the last review (step 380). If, at step 382, a packet being reviewed is a property update packet, it will be an update of a property of a graphic object having an entry in the Remotely Owned Items list of the interactive input system, in terms of the interactive input system. For example, if the packet being reviewed is an update property packet with an update to the position of a graphic object (step 382), the interactive input system has received from the other interactive input system position information in terms of the interactive input system, and updates the displayed position of the graphic object on the interactive input system (step 384).

If, at step 386, a packet being reviewed is an Item Destruction packet, the item is no longer positioned to at least partly coincide with the object placement region of the interactive input system, and the interactive input system removes the entry for the subject graphic object from its Remotely Owned Items list (step 388).

If, at step 390, a packet being reviewed is an Item Creation packet, the interactive input system adds an entry to its Remotely Owned Items list identifying the graphic object specified in the item creation packet (step 392).

If, at step 394, a packet being reviewed is an ownership change packet, the interactive input system removes from its Remotely Owned Items list the entry for the graphic object whose ownership is to be changed, and inserts an entry into its Locally Owned Items list for the graphic object. Ownership of the subject graphic object thereby changes from the other interactive input system to the present interactive input system.

While the above has been described as applicable to the coordination of graphic objects displayed and being manipulated on two interactive input systems, it will be understood that the principles set forth above are generally applicable to coordination of more than two interactive input systems.

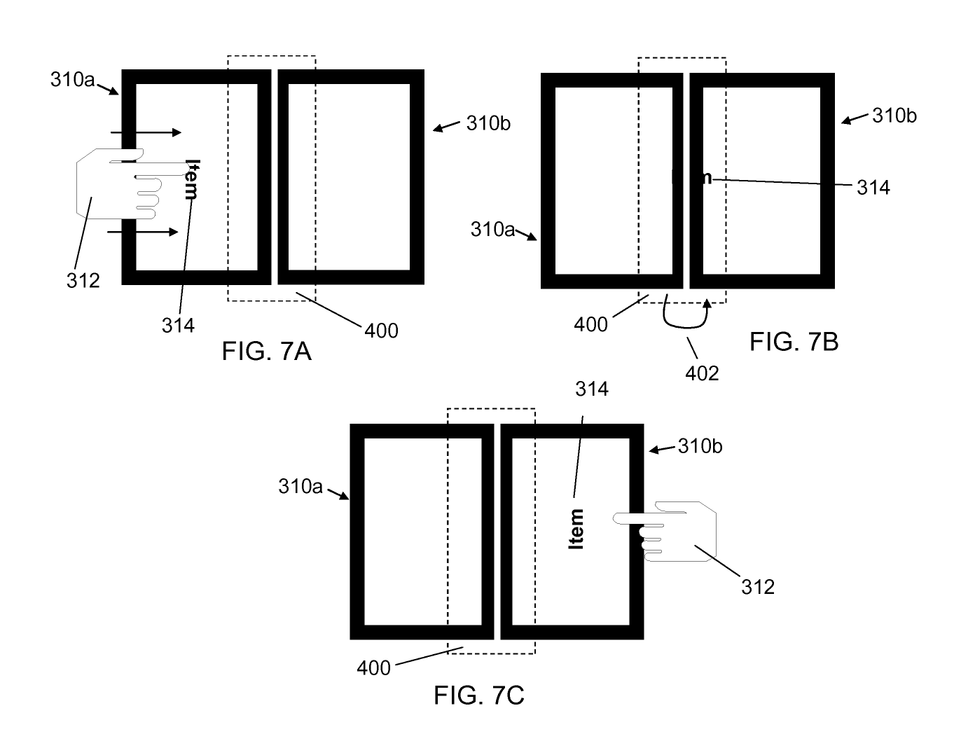

FIGS. 7A-7C show another embodiment in which a graphic object 314 is being translated by gesture input from a first display device corresponding to the first touch surface 310a of the first interactive input system that is positioned adjacent a second display device corresponding to the second touch surface 310b of the second interactive input system. In this embodiment, the interactive input systems are configured to be oriented differently in order to accommodate the users of the respective interactive input systems facing each other. More particularly, the top of the leftmost interactive input system is to the right of its display device as depicted in FIGS. 7A to 7C, whereas the top of the rightmost interactive input system is to the left of its display device. According to this embodiment, graphic objects displayed by the first interactive input system are re-oriented as they are moved for display by the second interactive input system in order to provide a user of the second interactive input system with the same orientation that the user of the first interactive input system enjoyed.

The above is achieved in this embodiment by automatically rotating the graphic object when it is moved to the second interactive input system. While an instantaneous re-orientation via rotation upon reaching a particular transition x-location would achieve this result, it is preferred that the rotation be somewhat continuous, such that the angle of rotation relates to the depth of the graphic object within a transition zone 400. For example, FIG. 7B shows the graphic object 314 being rotated in the direction 402 as it passed through the transition zone 400. FIG. 7C shows the graphic object 314 after it has exited the other side of the transition zone 400 to arrive upon the rightmost interactive input system correctly oriented.

Re-orienting of a graphic object is, in this embodiment, provided by execution of the software code in Code Listing B, below, or similar, during the above-described “Move Locally Owned Items” step in the flowchart of FIG. 7A:

Code Listing B

MoveLocallyOwnedItems( )
{
foreach (item in Locally Owned Items)

{
delta=item.MoveDelta( );
item.Position+=delta;
if (item.Position.IsUnderAnEdge( ) )

{
rotationrate=CalculateRotationRate( item.Position.LocalEdge,
item.Position.RemoteEdge)

rotatation=rotation+rotationrate.X*delta.X+rotationrate.Y*delta.Y;

}

}

}

CalculateRotationRate(Edge myEdge, Edge remoteEdge)

{
if ( myEdge==left && remoteEdge==right)

return rotationrate(0,0); //no rotation needed

if (myEdge==left && remoteedge==left)

return rotationrate(180/(leftbezel+rightbezel),0); //rotate

180 degrees as object moved in the X direction
if ( myEdge==right && remoteEdge==left)

return rotationrate(0,0); //no rotation needed

if (myEdge==right && remoteedge==right)

return rotationrate(180/(leftbezel+rightbezel),0); //rotate

180 degrees as object moved in the X direction
if ( myEdge==top && remoteEdge==top)

return rotationrate(0,180); //rotate 180 as object moved

in the Y direction
if ( myEdge==top && remoteEdge==bottom)

return rotationrate(0,0); //no rotation needed

}

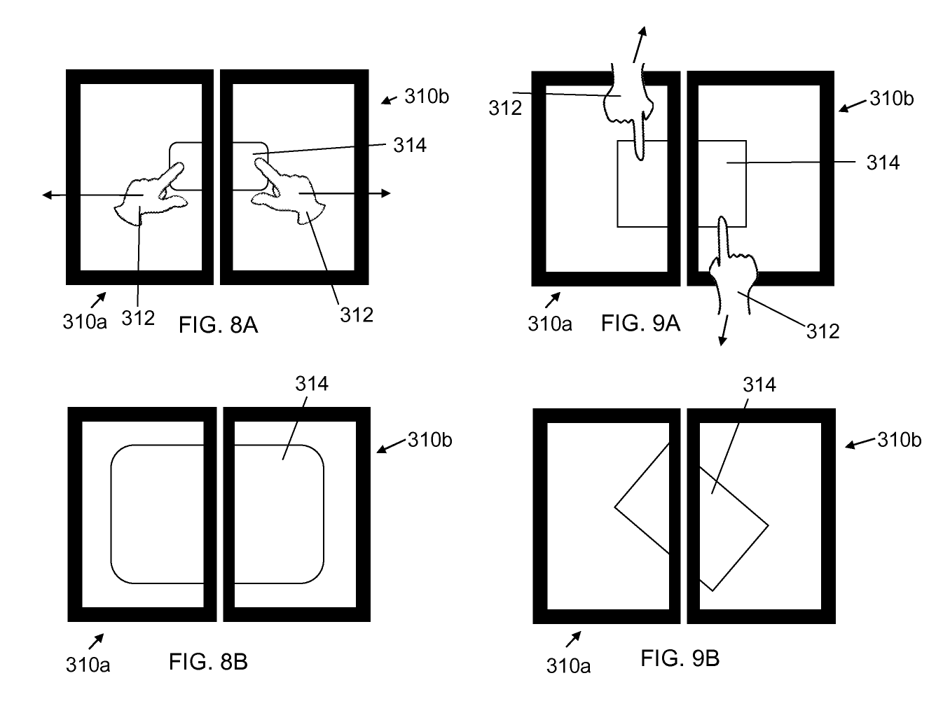

FIGS. 8A, 8B, 9A and 9B show graphic objects that are straddling the respective visible display regions of two different interactive input systems. More particularly, in these examples a respective portion of the graphic object is visible via both interactive input systems. According to this embodiment of the invention, contact events in respect of the graphic object made via both interactive input systems are coordinated to result in manipulation of the graphic object.

In FIG. 8A, a graphic object 314 is contacted using a first pointer via the leftmost interactive input system and also contacted using a second pointer via the rightmost interactive input system. As one or both of the pointers are dragged away from the center of the graphic object 314, the graphic object is increased in size, rather than translated in one direction or another. This is because the contact move events for both pointers are coordinated with each other, rather than the contact move events for one pointer overriding those of the other pointer. In this way, users of two different interactive input systems can collaborate to manipulate the graphic object 314.

In a similar manner, as shown in FIGS. 9A and 9B, the graphic object 314 is contacted using a first pointer via the leftmost interactive input system and also contacted using a second pointer via the rightmost interactive input system. As one or both of the pointers are rotated about the center of the graphic object 314, the graphic object 314 is rotated, rather than translated in one direction or another. This is because the contact move events for both pointers are coordinated with each other, rather than the contact move events for one pointer overriding those of the other pointer.

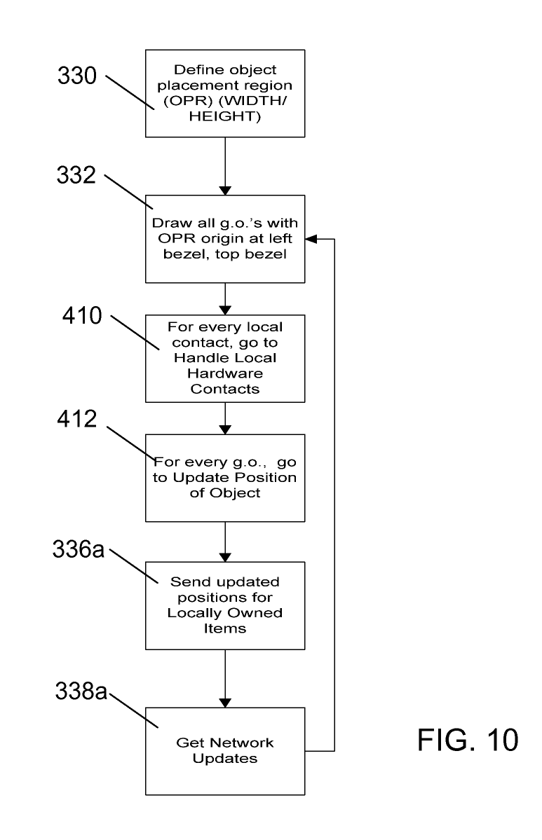

FIG. 10 is a flowchart for this embodiment. As can be seen, there is “Handle Local Hardware Contacts” step 410 following step 332, and itself followed by an “Update Position of Object” step 412 prior to step 336a for Sending Updated Positions for Locally Owned Items.

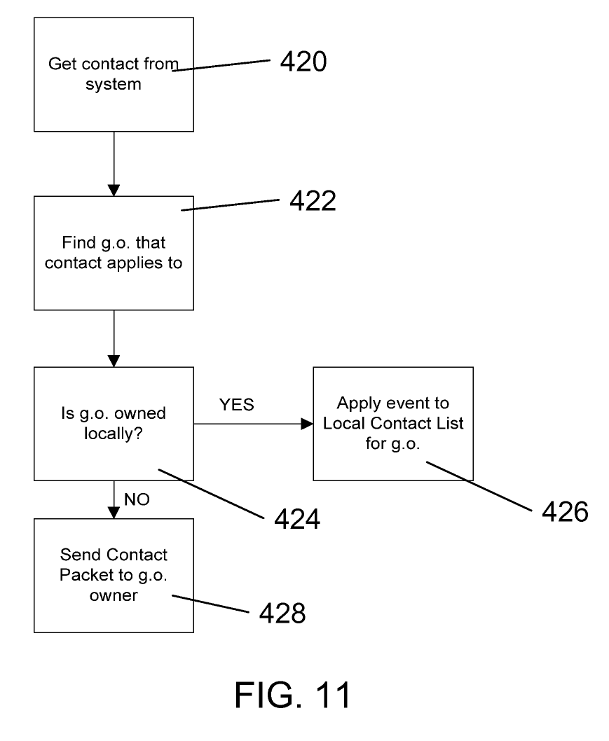

During the “Handle Local Hardware Contacts” process, as shown by the flowchart in FIG. 11, pointer data respecting any contacts on the interactive input system is employed to determine whether a graphic object 314 was touched and, in the event that a graphic object was touched, which graphic object 314 was touched (step 422). If, at step 424, a touched graphic object is in the Locally Owned Item list, a Local Contact list is updated with the contact data for the touched graphic object (step 426). If the graphic object is not in the Locally Owned Items list, a contact packet including the contact point position on the graphic object is provided to the other interactive input system (step 428). It will be understood that in the event that there are more than two coordinated interactive input systems, the contact packet is provided to the interactive input system having the graphic object in its Locally Owned Items list.

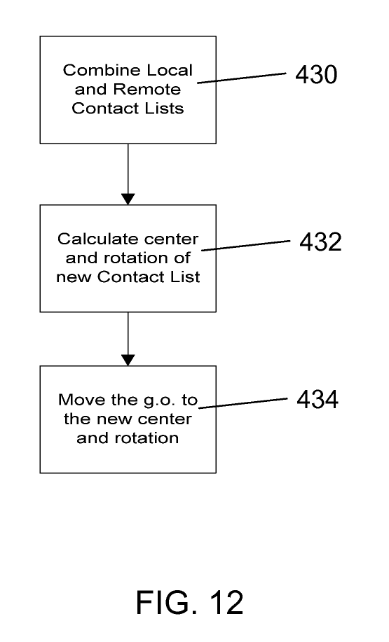

FIG. 12 is a flowchart showing the “Update Position of Object” step 412 in further detail. During this step, for each graphic object, the Local Contact list and the Remote Contact list are combined (step 430) such that if a graphic object has been contacted via two different interactive input systems, a new graphic object center and rotation angle is calculated by the interactive input system with the graphic object in its Locally Owned Items list, using the combined contact information (step 432). With the calculations having been completed, the corresponding properties of the graphic object can be adjusted such that, for example, the graphic object is moved to a new center point and rotated as may be the case (step 434). Furthermore, in accordance with the contacts, other actions can be performed, including expansion or minimization of the graphic object.

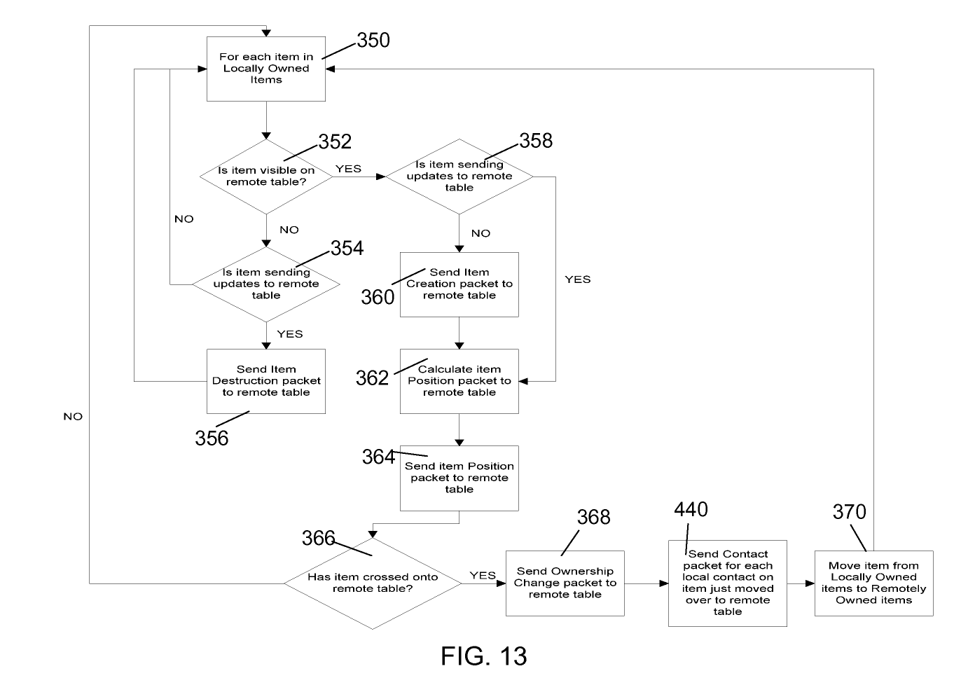

FIG. 13 is a flowchart showing in further detail the “Sending Updated Positions for Locally Owned Items” step 336a. It will be noted that the process during this step is nearly the same as that of step 336 described above in FIG. 6A, except that a contact packet for each local contact for the graphic object for which there has been an ownership change is sent to the other interactive input system as the new owner of the graphic object remote table 440 since it is now the owner. Finally, the object is moved from Locally Owned Items to Remotely Owned Items 370.

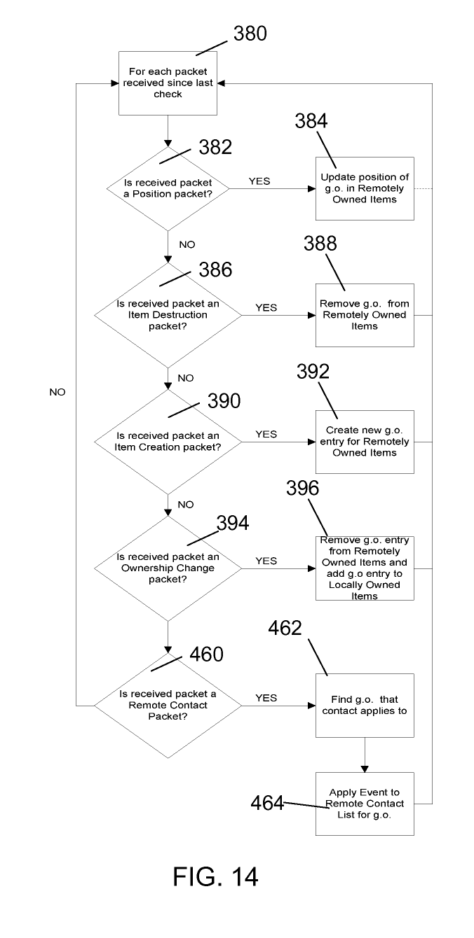

FIG. 14 shows in further detail the “Get Network Updates” step 338a. It will be noted that the process during this step is nearly the same as step 338 described above in FIG. 6C, except that, following step 394 it is determined at step 460 whether the received packet is a remote contact packet. In the event that the received packet is a remote contact packet, the graphic object to which the contact specified in the remote contact packet was applied is identified (step 462), and the specified contact is added to the Remote Contact list for that graphic object (step 464). Otherwise, the process reverts to step 380 to repeat the process for any additional packets received since the last check.

Although a number of embodiments have been described and illustrated with respect to a particular construction of multi-touch table interactive input system, those of skill in the art will appreciate that the invention described herein may be applied using other interactive input system technology platforms, such as tablets, interactive whiteboards, SMART Podium (interactive pen displays), and interactive displays.

While in embodiments described above the object placement region for an interactive input system includes its visible display area and the entire bezel surrounding the visible display area, alternatives are possible. For example, in an alternative embodiment, the object placement region includes the visible display area and the invisible auxiliary region that is only the portion of the bezel 316a falling between the visible display area and the outside edge of the first display device that is adjacent to the second display device. For example, with reference to FIGS. 5A to 5D, the auxiliary region for the first interactive input system may be defined only to be the vertical portion of the bezel 316a that is between the first and second display devices.

Furthermore, while level of pressure is based on the size of a touch point, in an alternative embodiment a pressure sensor may be coupled to the touch surface and/or the pointer itself to detect the pressure of the touch.

Those of skill in the art will also appreciate that the same methods of manipulating graphic objects described herein may also apply to different types of touch technologies such as surface-acoustic-wave (SAW), analog-resistive, electromagnetic, capacitive, IR-curtain, acoustic time-of-flight, or machine vision-based systems with imaging devices looking across the display surface.

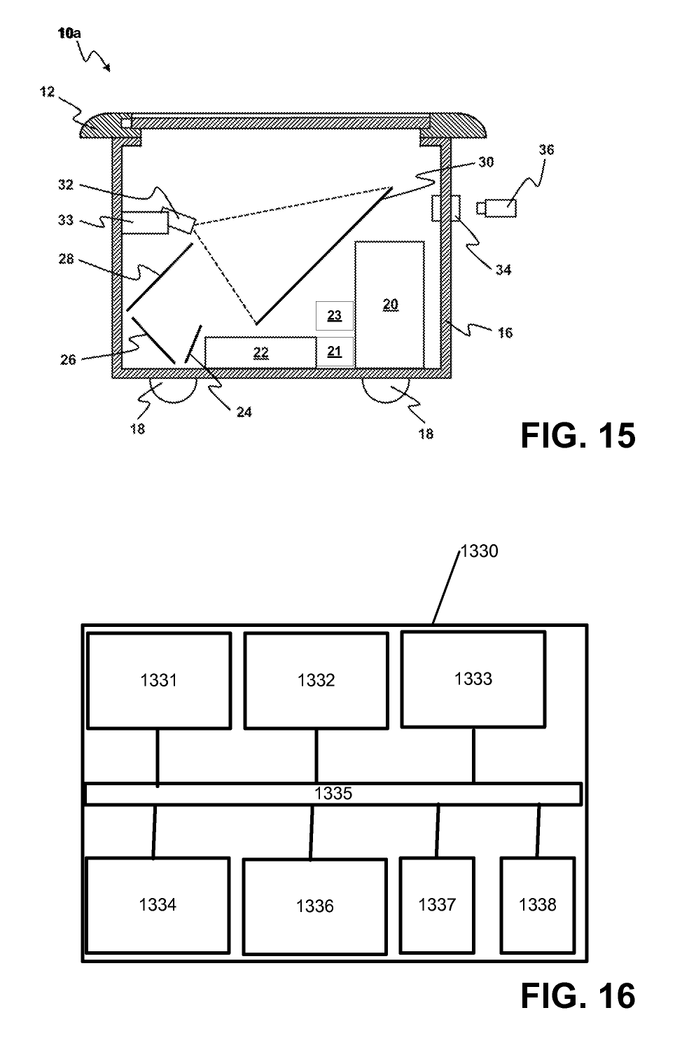

Turning now to FIG. 15, a sectional side view of an alternative interactive input system in the form of a touch table is shown and is generally identified by reference numeral 10a. Touch table 10a is equivalent to touch table 10 as described above, but also includes, housed within cabinet 16, a radio frequency identification (RFID) tag 21 that receives excitation signals emitted by an RFID exciter external to the interactive input system 10a and, in response, emits an RFID signal carrying an identifier that is unique to interactive input system 10a. The unique identifier may be received by an RFID reader and employed to detect that the interactive input system 10a is near to the RFID reader, as will be described. It will, be understood that while RFID tag 21 is excited by an external RFID exciter, in alternative embodiments the RFID tag 21 could be self-powered and therefore not require an exciter signal from an external RFID exciter. Touch table 10a is also equipped with a Bluetooth™ transceiver 23, for use as will be described.

As described above, advantages can accrue from enabling a portable device and at least one interactive input system such as that described above to cooperate, and in doing so provide the appearance that the display surfaces of the respective computing devices are portions of one larger display surface. In this embodiment, data such as files or objects may be transferred between the computing devices in such a manner as to provide the impression that the data being visually represented (as a graphic object, for example) on an originating portable computing device can be selectively “dropped” from the portable computing device such as a laptop or tablet computer onto a destination computing device such as a touch table interactive input system, and both visually represented and manipulated thereon.

FIG. 16 is a block diagram of an originating computing device, in this embodiment a laptop computer 1330. The laptop computer 1330 comprises a display 1331, a processing structure 1332, system memory 1333 (volatile and/or non-volatile memory), other non-removable or removable memory 1334 (a hard disk drive, RAM, ROM, EEPROM, CD-ROM, DVD, flash memory etc.) and a system bus 1335 coupling the various computer components to the processing structure 1332. The laptop computer 1330 in this embodiment also comprises a tilt sensor 1336 that comprises a compact accelerometer that produces different signals depending upon the physical orientation of the laptop computer 1330. The display 1331 of the laptop computer 1330 may be integrated with a touch surface such that objects displayed on the touch surface may be manipulated in response to touch input.

Laptop computer 1330 is also equipped with a proximity sensor 1337 which, in this embodiment, is an RFID (Radio Frequency Identification) reader (not shown) that receives RFID signals emitted by the RFID tag 21 of interactive input system 10a and those of any other interactive input systems having its own RFID tag 21 and that are nearby. Laptop computer 1330 is also equipped with a wireless communication interface 1338, in this embodiment a Bluetooth™ transceiver, for establishing wireless communications with one or more other computing devices. The components within the laptop computer 1330 cooperate to implement a system for transferring data from the laptop computer to another computing device, as will be described.

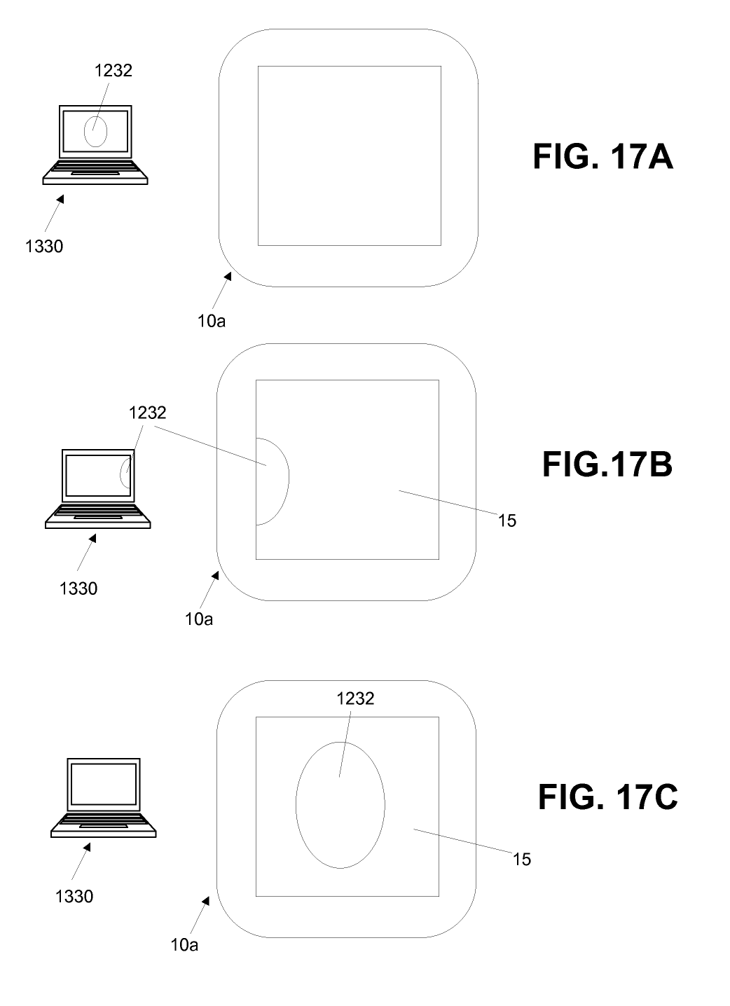

FIGS. 17A to 17C illustrate a visual representation of data, in this embodiment a graphic object, during the process of transferring the data in the above-described manner from the laptop computer 1330 to a destination computing device in the form of a touch table interactive input system 10a.

When the laptop computer 1330 is within a threshold physical distance of the touch table 10a, the RFID reader 1337 detects the RFID signal being emitted by the RFID tag 21 in the touch table 10a, and the laptop 1330 in response consults a lookup service either resident in memory 1333 or 1334 of the laptop computer 1330 or otherwise accessible by wired or wireless network to determine the network IP address of the touch table 10a. The laptop computer 1330 then automatically initiates a Bluetooth wireless network connection with the touch table 10a based on the determined network IP address. Should the laptop 1330 exceed a threshold physical distance from the touch table 10a, as approximated by the level of RFID signal being received at the laptop computer 1330 corresponding to the touch table 10a dropping below a threshold value, the Bluetooth connection with the touch table 10a is automatically broken.

The threshold physical distance may alternatively be approximated by the signal strength of the wireless signals being transferred via Bluetooth. Alternatively, signal strength may be resolved through a lookup table providing an association between signal strength of either the RFID signal or the Bluetooth connection, and physical distance. As such, in the event that there are multiple touch tables 10a in a particular vicinity, the wireless connection is established with the touch table 10a providing the strongest wireless signal. It will be understood that, for direct wireless connections between the originating and destination computing devices, the signal strength between the devices can be at least partly indicative of the distance between the two devices. However, in alternative embodiments using indirect wireless connections such as via WiFi, the signal strength per se will not necessarily be indicative of the distance between the computing devices. Rather, it will reflect at least partly the distance between the computing device that would be testing the signal strength to make the determination, and the intermediary with which it immediately connects, such as a server. As such, for indirect wireless communications, the RFID signal or a functional equivalent should be used to establish proximity.

Upon establishing the connection, a visual indication such as a flashing icon is provided on one or both of the laptop computer 1330 and the touch table 10a. In the event that two or more touch tables 10a provide substantially the same signal strength of the RFID signal for a given laptop computer 1330, the user of the laptop computer 1330 is provided with an option or menu for toggling between the multiple touch tables 10a with which the connection is to be established. Alternatively, the user is given the opportunity to select multiple touch tables 10a to which the object can be transferred in a single operation.

Once wireless communication is established between the laptop 1330 and at least one touch table 10a, the user may manipulate the laptop 1330 to select an object 1232 to be “dropped” (ie. copied) to the touch table 10a. To implement this, at the user's instruction, a copy of the object is wirelessly transferred to the touch table 10a, and then a visual indication in the form of an animation is provided on both the laptop 1330 and the touch table 10a so as to coordinate a disappearance of the object 1232 from the display of the laptop 1330 with the appearance of the transferred copy of the object 1232 to the display of the touch table 10a. In FIG. 17B, the object 1232 being transferred to the display screen 15 on the touch table 10a from the laptop 1330. As the object 1232 appears to be moving out of the laptop display screen 1331, it will begin appearing on the display screen 15 of the touch table 10a. In FIG. 17C, the object 1232 has fully been transferred from the laptop 1330 to the display screen 15 on the touch table 10a. Depending on the type of object 1232, or upon the implementation, different actions may occur. For example, if the object 1232 is a drawing type and an application running on the touch table 10a is a drawing program, the object 1232 will be displayed so as to simply appear as the drawing on the touch table 10a. If the object 1232 is a file and is transferred to the touch table 10a, the application software related to the file will open on the destination device. If no application software exists for the object that has been moved across, the object will be bounced back to the sender, or retained and the user prompted to identify and select such an application.

The visual indication of the transfer may be progressive disappearance of the visual representation of the object at an edge of the laptop computer screen, fading of the visual representation of the object, or flashing of the visual representation of the object. In the receiving interactive input system, the visual indication may be progressive appearance of the visual representation of the copy of the object at an edge of the interactive input system screen, gradual appearance and increased clarity from a faded representation, or a new visual representation of the object that is also flashing. Preferably the visual indication of the transfer on the originating and receiving computing devices are coordinated in some way with each other such that one progressively disappears while the other progressively appears.

Preferably the user's instruction for transferring data such as an object, file etc. will be in the form of a particular physical orientation of the laptop 1330 that is detected by the tilt sensor. More particularly, if the object 1232 is positioned on the display surface of the laptop computer 1330 in a predetermined transfer zone such as a drop tray and the laptop computer 1330 is tilted, the software on the laptop computer 1330 is triggered to begin transfer of the object 1232.

In order to ensure the transfer is seamless and fast, a copy of the object 1232 may be transferred to the touch table 10a immediately upon placement in the transfer zone, but only become accessible and visible on the touch table 10a after the laptop computer 10a has been tilted. However, if there are information security concerns, this may not be a desirable implementation. For example, it may be undesirable to have a copy of the object 1232 stored on the touch table 10a without explicit instructions from the user of the laptop computer 1330 in the form of a tipping triggering action.

Other alternative computing devices that may be used to transmit and receive can be various combinations of interactive tables, interactive whiteboards, Personal Data Assistants (PDAs), tablets, smart phones, slates, and the like. Preferably, the computing device is somewhat portable so that the orientations can be achieved with ease. Data that may be transferred include objects, drawings, data files, applications and the like, having visual representations as graphic objects (icons, pictures etc.). Other embodiments of proximity detectors can include inductive proximity sensors, capacitive proximity sensors, ultrasonic proximity sensors, and photoelectric sensors.

Furthermore, although orienting the laptop computer 1330 so as to provide the impression that upon “tipping” the laptop computer 1330 the data is being dropped has been described, other triggers could be employed. For example, sequences of tilt sensor signals could be tracked and used to trigger the transfer of data. Thus, sequences of signals for detecting shaking of the laptop computer 1330, or flipping of the laptop computer 1330, could be tracked to trigger the transfer.

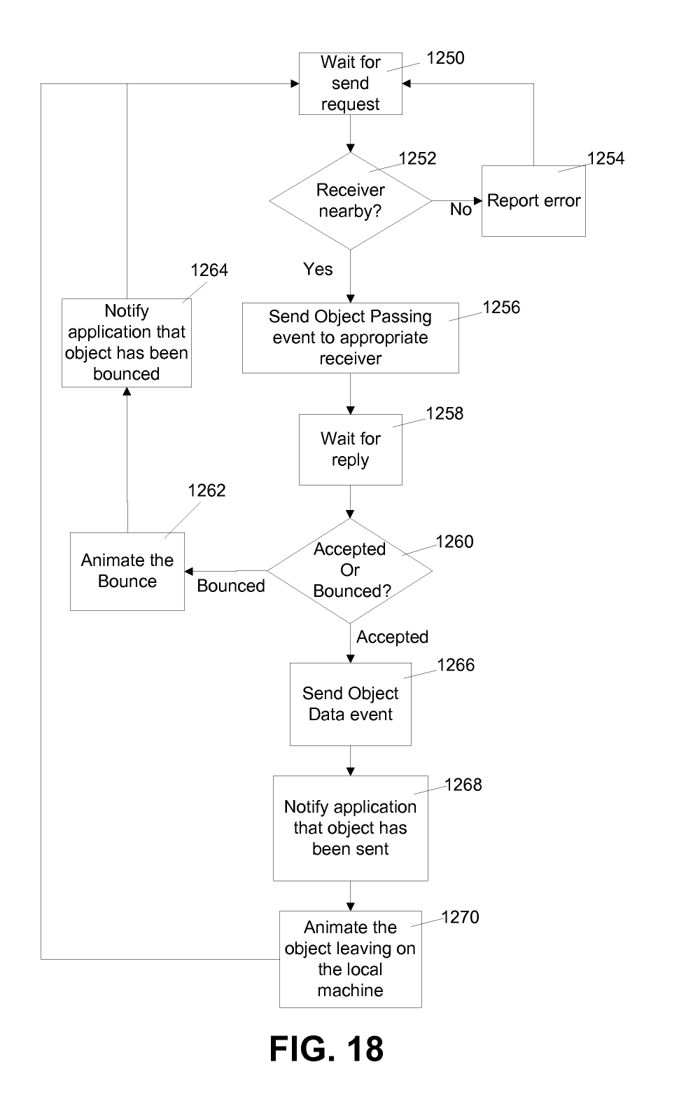

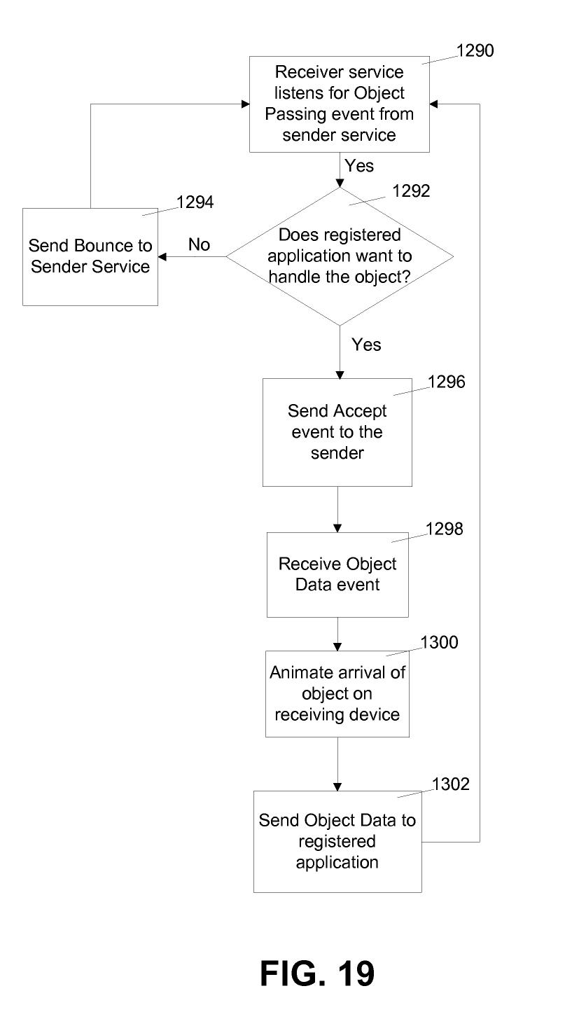

FIGS. 18 and 19 illustrate flowcharts for a Sender Service running on the laptop computer 1330 and a Receiver Service running on the touch table 10a. In the flowcharts, the Object Passing event contains the data type and the desired size of the object. The Accept event contains the destination position and the destination size of the object. The Object Data event contains the object data bytes, the source position and the source size. Those of skill in the art will appreciate that this is just one embodiment of the type of data contained in events and that many other types of data can be contained in these events.

Turning to FIG. 18, the Sender Service waits until a request to transfer an object is made on the originating device (step 1250). Once a request is made, verification to determine whether there are any target receiving computing devices within a predefined distance from the originating computing device to receive the object (step 1252). If there are no such target computing devices available, an indication of this state is presented on the sending device (step 1254). In this embodiment, such indication is in the form of an error message. If there is a proximal target computing device, an Object Passing event is sent to the target computing device (step 1256). The Sender Service then waits for a reply from the Receiver Service (step 1258). When the reply is received, the reply is checked to see if the Object Passing event was accepted or bounced (ie., rejected) (step 1260). If the response received is a Bounce message, the object displayed on the laptop computer 1330 is animated, in such a fashion that the object appears to hit the edge of the display of the originating device and bounce back (step 1262). The sending application is then notified that the proposed receiving computing device has rejected or is unable to handle receiving the object (step 1264). The sending device then returns to the state of waiting for a request to send an object (step 1250).

If the sending service receives an Accept event from the receiving computing device, an Object Data event is transmitted to the receiving computing device (step 1266), and the application is notified by the Sender Service that the object has been transferred (step 1268). A smooth animation is then executed depicting the object being moved from the originating computing device to the target computing device (step 1270). Once the animation is complete, the Sender Service waits for another send request.

Turning to FIG. 19, the Receiver Service running on the target computing device, once initiated, waits until an Object Passing event is received from the originating computing device (step 1290). When the Object Passing event arrives, a check is made to see if any of the registered applications wishes to and are able to handle this object (step 1292). If the registered application does not want to or is unable to handle the object being sent, a bounce message is sent back to the Sender Service (step 1294). The Receiver Service then returns back into a listening mode, waiting for the next Object Passing event. If the registered application wants to and is able to handle the object being sent, the Receiver Service sends an Accept event to the Sender Service (step 1296). Upon reception of the Object Data event (step 1298), the receiving device produces an animation that shows the object moving progressively from the edge of the display into full view on the receiving device (step 1300). The object data is then sent to the registered application that can process the object (step 1302) in the receiving computing device. The Receiver Service then returns to listening for an Object Passing event.

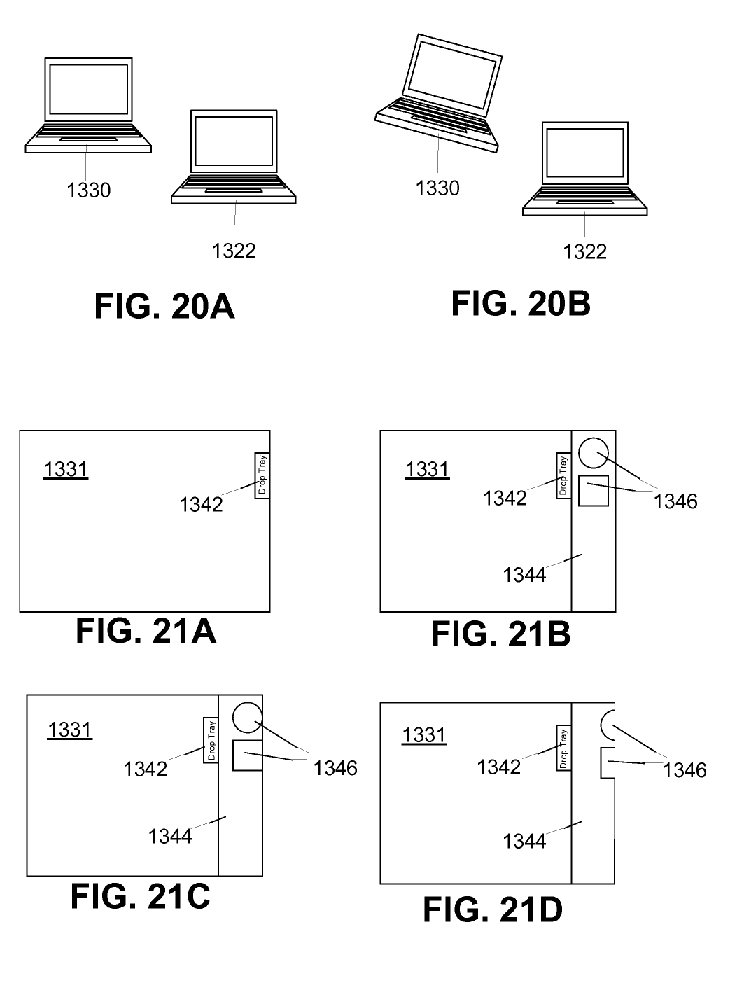

FIGS. 20A and 20B illustrate a tilt motion used to transfer an object 1232 from an originating laptop computer 1330 to a target laptop computer 1322. In FIG. 20A, the originating laptop computer 1330, equipped with a proximity detector in the form of an RFID reader, detects that target laptop computer 1322 is nearby. Communications between the two laptop computers 1330 and 1322 is established via a wireless network as described above. In FIG. 20B, the originating laptop computer 1330 is tilted towards the target laptop computer 1322, triggering the sending of an object 1232 to the target laptop computer 1322 that is located within the predefined proximate distance.

FIGS. 21A to 21D illustrate the display screen of the originating laptop computer 1330 during the tilt gesture described above in connection with FIGS. 20A and 20B. In FIG. 21A, the originating laptop computer 1330 is horizontally oriented, and thus has not yet been tilted. A drop tray tab 1342 is located in the right hand corner of the display screen 1331. In FIG. 21B, the drop tray tab 1342 extends inwards to create a drop tray area 1344 to display objects 1346 that have been placed in the drop tray (by dragging or dropping), and to permit dragging of objects 1346 into the drop tray. The objects 1346 in the drop tray are to be transferred to the target laptop computer 1322. In FIG. 21C, the originating laptop computer 1330 has been tilted towards the target laptop computer 1322. An animation is presented such that the objects 1346 in the drop tray area 1344 appear to slide off the display screen 1331 of the originating laptop computer 1330. In FIG. 21D, the objects 1346 continue to be animated to appear to be sliding off the display screen 1331.

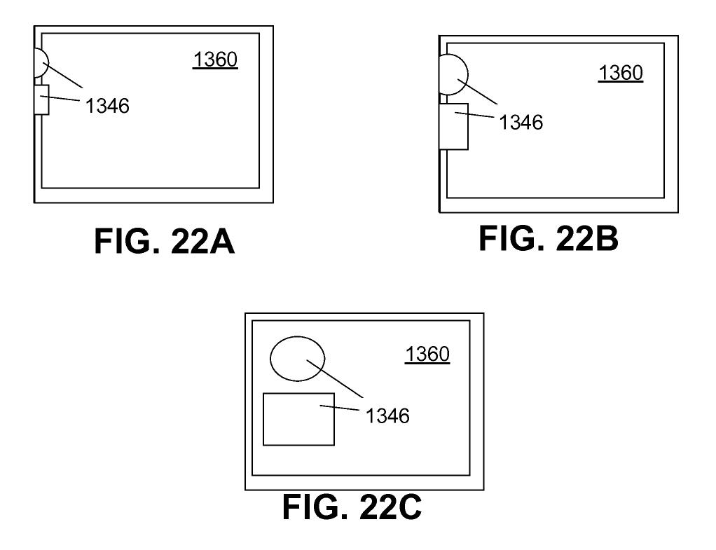

FIGS. 22A to 22C illustrate the display screen 1360 of the target laptop computer 1322 as it receives the objects 1346 from the originating laptop computer 1330. The software application suitable for receiving the objects 1346 will be executing on the target laptop computer 1322 or, upon transfer, will automatically be opened. For example, if a document object such as a Microsoft Word™ file is transferred from the originating computer, a word processor such as Microsoft Word™ is automatically opened on the target laptop computer. Alternatively, if a drawing is transferred, and the drawing program is currently open in the target laptop computer 1322, then the drawing object is simply added as part of the drawing file, or a new drawing file is opened and the drawing object placed therein. As the objects 1346 appear to be sliding out of the screen of the originating laptop computer 1330, the copies of the objects 1346 begin appearing into the screen 1360 of the target laptop computer 1322, as shown in FIG. 22A. In FIG. 22B, the copies of objects 1346 continue to move fully into visibility on the screen 1360 of the target laptop computer 1322. At the same time, the copies of objects 1346 begin to enlarge to a predetermined size on target laptop computer 1322. In FIG. 22C, the copies of objects 1346 have been fully transferred to the desired application of the target laptop computer 1322. If, however, the appropriate software is not available on the target laptop computer 1322, the objects 1346 are not displayed on the display screen of the originating device, and are deleted. The Received Service informs the Sender Service, which animates the objects 1346 on the originating laptop to appear as though the objects 1346 were sent back to the originating device, such as for example animating the objects 1346 with a bounce. In another embodiment, the objects 1346 may just simply be stopped at the edge of the drop tray area 1344 on the originating computer, providing the user with the indication that the objects 1346 will not be transferred.

In an alternative embodiment, there can more than one portable computing device tilted simultaneously. For example, there can be two adjacent computing devices containing objects in each of their respective drop trays that are tilted towards a third computing device. Objects in the drop tray can travel from the first tilted computing device, through to the second tilted computing device and travel towards the third computing device. Objects in the drop tray of the second tilted computing device will travel to the third computing device located within a predefined proximate distance.

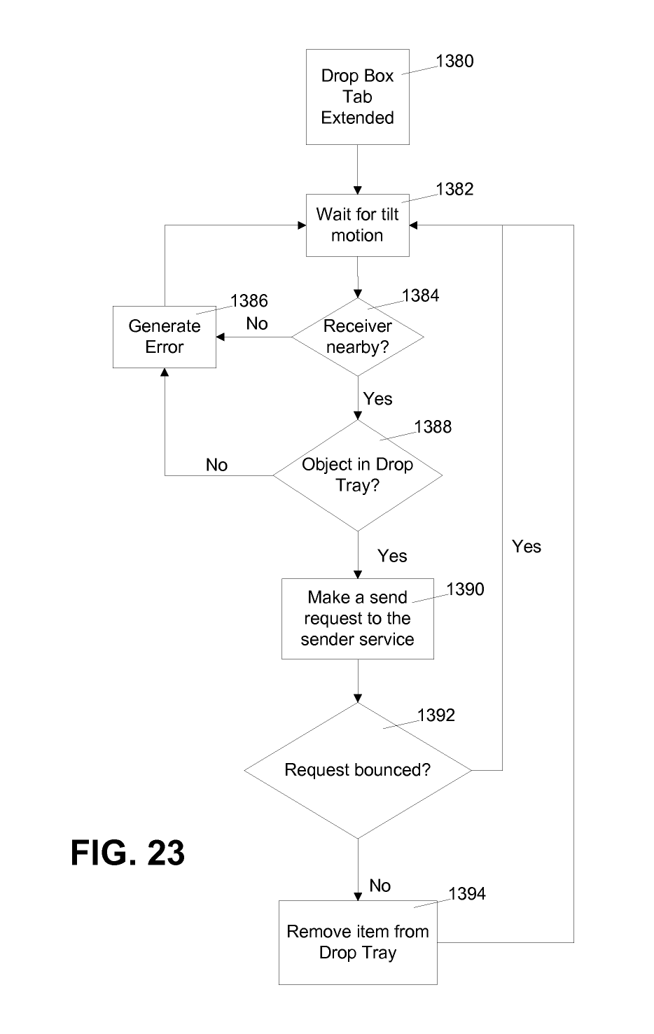

A flowchart for actions performed during the tilt gesture is illustrated in FIG. 23. The drop tray tab of the originating laptop computer 1330 is extended (step 1380) and presents a drop box area 1344, or transfer zone. The drop box area 1344 may be presented if it is manually dragged open by a user, or automatically caused to open when two portable computing devices are within a predetermined proximate distance of each other or if an object 1346 is dragged or dropped into the drop tray 1344. The originating laptop computer 1330 waits until the tilt sensor acknowledges that it has been tilted (step 1382). Upon detecting that the device has been tilted, a verification is first made to see if a qualifying destination laptop computer 1322 is within a pre-determined proximate distance of the originating laptop computer 1330 (step 1384). If there is no such destination laptop computer within the pre-determined proximate distance, an error message is generated and the originating laptop computer 1330 having the drop tray 1344 returns to waiting for a tilt motion (step 1386). If a destination laptop computer 1322 is within the defined proximate distance, the next verification is to check if an object 1346 is within the Drop Tray area 1344 (step 1388). If there is no object 1346, an error or notification message or indication is generated and the origination laptop computer 1330 will return to waiting for a tilt motion (step 1382). If an object 1346 is in the Drop Tray 1344, then a send request is sent to the sender server (step 1390). The sender server algorithm will proceed as previously described above, with the exception that it will not have to check if a destination laptop computer 1322 is nearby, since this check has been done in step 1384. If a bounce message is returned (step 1392), the object 1346 will be shown to try to cross but will be animated to bounce back to the display screen 1331 of the originating laptop computer 1330 (this animation is implemented within the Sender Service). The laptop computer 1330 will return to waiting for a tilting motion (step 1382). If a notification that the object 1346 has been sent is received, the Sender Service will animate the objects 1346 that are being transferred and the objects 1346 will be removed from the Drop Tray tab 1344. The originating laptop computer 1330 then returns to waiting for the next tilt motion (step 394).

In an alternative embodiment, two touch tables or other interactive input systems may be pushed together to form an integrated surface. A laptop computer as an originating device can be brought near to an interactive input system, and objects from the interactive input system can be transferred onto the laptop. Furthermore, a tablet computer can drop items onto a student's smartphone, laptop, another tablet, or a personal digital assistant (PDA).

While the use of RFID signals has been described for determining whether two computing devices are near to each other, it will be understood that other implementations for determining whether two computing devices are near to each other may be employed.

In an alternative embodiment, objects are not deleted from the originating computing device after copies have been transferred to the receiving computing device. Rather, the objects may be retained for transferring of copies to other receiving computing devices.

In an alternative embodiment, data transferred to a receiving computing device can be transferred back to the originating computing device with a gesture. For example, if the originating and receiving computing devices are still in wireless communications with each other, the user of the receiving computing device would be able to transfer back data that had been transferred to it. Such might be done with a particular gesture such as sliding the visual representation of the data (icon etc.) towards the edge of the screen of the receiving device so as to “throw” it off of the screen. A sender service similar to the one described above would also be resident on the receiving computing device, and a receiver service similar to the one described above would also be resident on the originating computing device. As such, data could be transferred back and forth between computing devices. It will be understood that, if the receiving computing device is not portable, it triggering transfer of the data back to the originating computing device would more usefully be done with an action other than tilting the receiving computing device (which could be physically difficult with a non-portable computing device), such as using a “throwing” touch gesture on a touch screen, for example.

In an alternative embodiment, the originating computing device retains a level of control over the copies of any objects transferred to a receiving computing device, such that, from the originating computing device, the copies of the objects can be retrieved/removed from the receiving computing device. This would permit a teacher, for example, to control which objects remain on a touch table from his or her laptop computer after a lesson is complete, or for the teacher to exercise some control over the number of copies of a disseminated object.

Although a number of embodiments have been described and illustrated with respect to a multi-touch interactive input system in the form of a touch table, and with respect to a laptop computer or computers cooperating therewith, those of skill in the art will appreciate that the invention described herein may be applied using many other types of computing devices, including other interactive input system technology platforms, such as tablets, interactive whiteboards, SMART™ Podium (interactive pen displays), and interactive displays.

While the wireless communication is described above as being established using Bluetooth, alternative methods for establishing wireless communications either directly between devices, or via one or more intermediary devices such as one or more servers or wireless access points. For example, wireless communication may be established using Wifi (802.11a/b/g/n), zigbee (802.15.4), UWB (Ultra Wideband 802.15.3), wireless USB (Universal Serial Bus), other radiofrequency (RF) methods, Infrared, and/or using telecommunications protocols such as CDMA (Code Division Multiple Access), TDMA (Time Division Multiple Access), GSM (Global System for Mobile communications), WiMAX (Worldwide Interoperability for Microwave Access) and LTE (Long Term Evolution).

The systems described herein may comprise program modules including but not limited to routines, programs, object components, data structures etc. and may be embodied as computer readable program code stored on a computer readable medium. The computer readable medium is any data storage device that can store data, which can thereafter be read by a computer system. Examples of computer readable media include for example read-only memory, random-access memory, flash memory, CD-ROMs, magnetic tape, optical data storage devices and other storage media. The computer readable program code can also be distributed over a network including coupled computer systems so that the computer readable program code is stored and executed in a distributed fashion or copied over a network for local execution.

Although preferred embodiments of the present invention have been described, those of skill in the art will appreciate that variations and modifications may be made without departing from the spirit and scope thereof as defined by the appended claims.

What is claimed is:

1. A method in a computing device of transferring data to another computing device comprising:
establishing wireless communication with the other computing device;
designating data for transfer to the other computing device; and
in the event that the computing device assumes a predetermined orientation, automatically initiating wireless transfer of the data to the other computing device.

2. The method of claim 1, wherein the predetermined orientation comprises the computing device being tilted a threshold degree off of the horizontal.

3. The method of claim 1, further comprising:
prior to establishing wireless communications, detecting that the other computing device is within a threshold distance of the computing device.

4. The method of claim 3, wherein detecting comprises detecting an RFID signal emitted by at least the other computing device.

5. The method of claim 4, wherein the RFID signal is triggered by an RFID exciter that is separate from the computing device.

6. The method of claim 1, wherein the computing devices establishes wireless communication directly with the other computing device using Bluetooth.

7. The method of claim 1, wherein the computing device establishes wireless communication indirectly with the other computing device using WiFi.

8. The method of claim 1, wherein the data comprises a file.

9. The method of claim 1, wherein the data comprises at least one object.

10. The method of claim 1, further comprising:
in the event that a signal from the other computing device is received indicating that it is unable to receive the designated data, displaying an indication that transfer of the designated data has been terminated.

11. The method of claim 1, further comprising:
during the transfer, animating a visual representation of the data.

12. The method of claim 11, wherein the animating comprises causing the visual representation to progressively disappear from view.

13. The method of claim 11, wherein the animating comprises causing the visual representation to flash.

14. The method of claim 11, wherein the animating comprises causing the visual representation to fade.

15. The method of claim 1, wherein the designating is conducted in accordance with received user input.

16. The method of claim 15, wherein the received user input comprises input for moving a visual representation of the designated data to coincide with a transfer zone.

17. The method of claim 16, wherein a visual representation of the transfer zone automatically appears on a display of the computing device when the short range wireless connection is established.

18. The method of claim 16, wherein the visual representation of the transfer zone is depicted as a drawer.

19. The method of claim 4, wherein in the event that an RFID signal from more than one other computing device is detected, automatically selecting one of the other computing devices with which the short range wireless connection is to be established.

20. The method of claim 19, wherein the automatically selecting comprises selecting the other computing device having the highest RFID signal strength.

21. The method of claim 3, wherein in the event that more that one other computing device is within the threshold distance, receiving user input to select one of the other computing devices with which the wireless communication is to be established.

22. The method of claim 3, wherein in the event that more than one other computing device is within the threshold distance, automatically establishing the wireless communication with the more than one other computing device, wherein transferring comprises transferring to all of the more than one other computing device.

23. The method of claim 1, further comprising transferring the designated data back to the computing device from the other computing device.

24. The method of claim 23, wherein transferring the designated data back to the computing device from the other computing device is triggered by a user action on the computing device.

25. The method of claim 23, wherein transferring the designated data back to the computing device from the other computing device is triggered by a user action on the other computing device.

26. A system in a computing device for transferring data to another computing device, comprising:
a wireless communications interface establishing wireless communication with the other computing device;
a user interface receiving user input for designating data for transfer to the other computing device;
a sensor for sensing orientation of the computing device; and
processing structure for, in the event that the sensor senses a predetermined orientation, automatically initiating wireless transfer of the data to the other computing device.

27. The system of claim 26, wherein the sensor is a tilt sensor, and the predetermined orientation comprises the computing device being tilted a threshold degree off of the horizontal.

28. The system of claim 26, further comprising:
a detector for detecting that the other computing device is within a threshold distance of the computing device prior to establishing the wireless communication.

29. The system of claim 28, wherein the detector detects an RFID signal emitted by at least the other computing device.

30. The system of claim 29, wherein the RFID signal is triggered by an RFID exciter that is separate from the computing device.

31. The system of claim 26, the computing devices establishes wireless communication directly with the other computing device using Bluetooth.

32. The system of claim 26, wherein the computing device establishes wireless communication indirectly with the other computing device using WiFi.

33. The system of claim 26, wherein the data comprises a file.

34. The system of claim 26, wherein the data comprises at least one object.

35. The system of claim 26, wherein the processing structure, in the event that a signal from the other computing device is received indicating that it is unable to receive the designated data, displays an indication that transfer of the designated data has been terminated.

36. The system of claim 26, wherein the processing structure animates the visual representation of the data during the transfer.

37. The system of claim 36, wherein the processing structure animates by causing the visual representation to progressively disappear from view.

38. The system of claim 36, wherein the processing structure animates by causing the visual representation to flash.

39. The system of claim 36, wherein the processing structure animates by causing the visual representation to fade.

40. The system of claim 26, wherein the designating is conducted in accordance with received user input.

41. The system of claim 40, wherein the received user input comprises input for moving a visual representation of the designated data to coincide with a transfer zone.

42. The system of claim 41, wherein a visual representation of the transfer zone automatically appears on a display of the computing device when the wireless communication is established.

43. The system of claim 41, wherein the visual representation of the transfer zone is depicted as a drawer.

44. The system of claim 29, wherein in the event that an RFID signal from more than one other computing device is detected, the wireless communications interface automatically selects one of the other computing devices with which the wireless communication is to be established.

45. The system of claim 44, wherein the automatically selecting comprises selecting the other computing device having the highest RFID signal strength.

46. The system of claim 28, wherein in the event that more that one other computing device is within the threshold distance, the wireless communications interface selects one of the other computing devices with which the wireless communication is to be established in accordance with user input.

47. The system of claim 28, wherein in the event that more than one other computing device is within the threshold distance, the wireless communications interface automatically establishes the wireless communication with the more than one other computing device, wherein transferring comprises transferring to all of the more than one other computing device.

48. The system of claim 26, wherein in the processing structure coordinates transferring the designated data back to the computing device from the other computing device.

49. The system of claim 48, wherein transferring the designated data back to the computing device from the other computing device is triggered by a user action on the computing device.

50. The system of claim 48, wherein transferring the designated data back to the computing device from the other computing device is triggered by a user action on the other computing device.

51. A computer readable medium embodying a computer program executable on a processing structure of a computing device for transferring data to another computing device, the computer program comprising:
computer program code for establishing a wireless communications with the other computing device;
computer program code for designating data for transfer to the other computing device; and
computer program code for automatically initiating wireless transfer of the data to the other computing device, in the event that the computing device assumes a predetermined orientation.

52. An interactive input system comprising:
a first display device; and
processing structure communicating with the first display device, the processing structure defining a graphic object placement region for the first display device that comprises at least a visible display region of the first display device and an invisible auxiliary region between the visible display region and an outside edge of the first display device, the processing structure, in the event that the graphic object enters the invisible auxiliary region, automatically moving the graphic object through the invisible auxiliary region until at least a portion of the graphic object enters a visible display region of a second display device of a second interactive input system.

53. The interactive input system of claim 52, further comprising a touch screen associated with the display device, wherein the graphic object may be moved using a pointer in contact with the touch screen.

54. The interactive input system of claim 53, wherein the processing structure automatically moves the graphic object in the visible display region in accordance with touch input using the pointer.

55. The interactive input system of claim 54, wherein in the event that the graphic object has been set in motion towards the invisible auxiliary region at a velocity that is below a threshold level, the processing structure automatically stops the graphic object from moving into the invisible auxiliary region.

56. The interactive input system of claim 55, wherein the visible display region of the first display device is accorded a friction factor by the processing structure that causes the graphic object when set in motion to eventually slow to a stop.

57. The interactive input system of claim 54, wherein in the event that the graphic object has been set in motion towards the invisible auxiliary region at a velocity that is below a threshold level, the processing structure automatically increases the velocity of the graphic object as it moves through the invisible auxiliary region.

58. A method of handling a graphic object in an interactive input system having a first display device, the method comprising:
defining a graphic object placement region for the first display device that comprises at least a visible display region of the first display device and an invisible auxiliary region between the visible display region and an outside edge of the first display device; and
in the event that the graphic object enters the invisible auxiliary region, automatically moving the graphic object through the invisible auxiliary region until at least a portion of the graphic object enters a visible display region of a second display device of a second interactive input system.

59. The method of claim 58, wherein the graphic object is automatically caused to continue to move into the visible display region of the second display device via an invisible auxiliary region of the second display device.

60. A computer readable medium embodying a computer program for handling a graphic object in an interactive input system having a first display device, the computer program comprising:
program code for defining a graphic object placement region for the first display device that comprises at least a visible display region of the first display device and an invisible auxiliary region between the visible display region and an outside edge of the first display device; and
program code for, in the event that the graphic object enters the invisible auxiliary region, automatically moving the graphic object through the invisible auxiliary region until at least a portion of the graphic object enters a visible display region of a second display device of a second interactive input system.

61. An interactive input system comprising:
a first display device positioned near to a second display device of another interactive input system; and
processing structure communicating with the first display device, the processing structure defining a transition region comprising a portion of a visible display region of the first display device and portion of a visible display region of the second display device, the first visible display region having a different orientation than the second visible display region, the processing structure, in the event that the graphic object enters the transition region, automatically reorienting the graphic object by rotating the graphic object, wherein the angle of rotation is based on the distance the graphic object has traveled through the transition region.

62. A method of handling a graphic object in an interactive input system having a first display device positioned near to a second display device of a second interactive input system, the method comprising:
defining a transition region comprising a portion of a visible display region of the first display device and portion of a visible display region of the second display device, the first visible display region having a different orientation than the second visible display region; and
in the event that the graphic object enters the transition region, automatically reorienting the graphic object by rotating the graphic object, wherein the angle of rotation is based on the distance the graphic object has traveled through the transition region.

63. A computer readable medium embodying a computer program for handling a graphic object in an interactive input system having a first display device positioned near to a second display device of a second interactive input system, the computer program comprising:
program code for defining a transition region comprising a portion of a visible display region of the first display device and portion of a visible display region of the second display device, the first visible display region having a different orientation than the second visible display region; and
program code for, in the event that the graphic object enters the transition region, automatically reorienting the graphic object by rotating the graphic object, wherein the angle of rotation is based on the distance the graphic object has traveled through the transition region.

64. An interactive input system comprising:
a first display device;
processing structure receiving data for contact points on a graphic object from both the interactive input system and another interactive input system, the processing structure aggregating the contact points and, based on the aggregated contact points, manipulating the graphic object, the processing structure updating the first and second interactive input systems based on the manipulating.

65. A method of manipulating a graphic object presented on both a first interactive input system and a second interactive input system, the method comprising:
receiving data for contact points on the graphic object made via both the first interactive input system and the second interactive input system;
aggregating the contact points;
based on the aggregated contact points, manipulating the graphic object; and
updating the first and second interactive input systems based on the manipulating.

66. A computer readable medium embodying a computer program for manipulating a graphic object presented on both a first interactive input system and a second interactive input system, the computer program comprising:
program code for receiving data for contact points on the graphic object made via both the first interactive input system and the second interactive input system;
program code for aggregating the contact points;
program code for, based on the aggregated contact points, manipulating the graphic object; and
program code for updating the first and second interactive input systems based on the manipulating.
